(19) United States
(12) Patent Application Publication
(10) Pub. No.: US 2023/0415042 A1
(43) Pub. Date: Dec. 28, 2023

(54) VIRTUAL EFFECT ON VIRTUAL OBJECT

(71) Applicant: Tencent Technology (Shenzhen) Company Limited, Shenzhen (CN)

(72) Inventor: Yizhou LI, Shenzhen (CN)

(73) Assignee: Tencent Technology (Shenzhen) Company Limited, Shenzhen (CN)

(21) Appl. No.: 18/244,181

(22) Filed: Sep. 8, 2023

Related U.S. Application Data
(63) Continuation of application No. PCT/CN2023/089386, filed on Apr. 20, 2023.

(30) Foreign Application Priority Data
May 30, 2022 (CN) 202210614755.5

(51) Int. Cl. A63F 13/56; A63F 13/577

(52) U.S. Cl. CPC A63F 13/56; A63F 13/577; A63F 13/537

(57) ABSTRACT

In a method for processing a virtual effect in a virtual scene, the virtual effect is generated in the virtual scene. The virtual effect is configured to change an attribute value of a virtual object that is located within a functional range of the virtual effect. Based on positional relationships between a plurality of body parts of the virtual object and the virtual effect in the virtual scene, a sub-attribute change value for each of the plurality of body parts of the virtual object that is affected by the virtual effect is determined. A change to the attribute value of the virtual object is determined based on the sub-attribute change value of each of the plurality of body parts of the virtual object that is affected by the virtual effect.

### RELATED APPLICATIONS

This application is a continuation of International Application No. PCT/CN2023/089386, filed on Apr. 20, 2023, which claims priority to Chinese Patent Application No. 202210614755.5, and entitled “VIRTUAL OBJECT DISPLAY METHODS AND APPARATUSES, DEVICE, MEDIUM, AND PROGRAM PRODUCT,” filed on May 30, 2022. The entire disclosures of the prior applications are incorporated herein by reference.

### FIELD OF THE TECHNOLOGY

Embodiments of this disclosure relate to the field of animation generation, including to virtual object display methods and apparatuses, a device, a medium, and a program product.

### BACKGROUND OF THE DISCLOSURE

In application programs that support virtual scenes, virtual props that can cause damage to virtual objects are provided, for example: a virtual grenade prop.

In related technologies, a mechanism by which the virtual grenade prop causes damage to virtual objects is as follows: When the virtual grenade prop is exploded at a specified position in a virtual scene, there is a corresponding explosion range. When a virtual object is within the explosion range, a health point of the virtual object would decrease by a corresponding value.

The damage mechanism of the virtual grenade prop in the above related technologies is relatively simple. When a virtual object uses a virtual grenade prop to attack another virtual object, the virtual object needs to throw the virtual grenade prop at a designated throwing position, and the another virtual object can be damaged only if the another virtual object is within the explosion range. This makes it necessary for a player to find a correct position to throw the virtual grenade prop. As a result, the game time is extended, and computer overhead is increased.

### SUMMARY

Embodiments of this disclosure provide virtual object display methods and apparatuses, a device, a non-transitory computer-readable storage medium, and a program product, which can improve the hit rate of a virtual prop for exerting an influence on a virtual object. The technical solutions are as follows:

According to one aspect, a method for processing a virtual effect in a virtual scene is provided. In the method, the virtual effect is generated in the virtual scene. The virtual effect is configured to change an attribute value of a virtual object that is located within a functional range of the virtual effect. Based on positional relationships between a plurality of body parts of the virtual object and the virtual effect in the virtual scene, a sub-attribute change value for each of the plurality of body parts of the virtual object that is affected by the virtual effect is determined. A change to the attribute value of the virtual object is determined based on the sub-attribute change value of each of the plurality of body parts of the virtual object that is affected by the virtual effect.

According to another aspect, a virtual object display method is provided. A second virtual object is displayed, the second virtual object including a plurality of object parts, and the second virtual object being a virtual object mainly controlled by a current terminal. A virtual prop thrown into a virtual scene is displayed, the virtual prop being used for triggering a specified function within a functional range after being thrown into the virtual scene, and the specified function being used for exerting an influence on an attribute value of a virtual object located in the functional range. The specified function of the virtual prop triggered within the functional range is displayed. An attribute influence result of the second virtual object is displayed in response to the second virtual object being located in the functional range, the attribute influence result being a result obtained by integrating sub-attribute influence results respectively corresponding to the plurality of object parts, and the sub-attribute influence results being influence results respectively generated by the plurality of object parts under the specified function.

According to another aspect, an apparatus is provided. The apparatus includes processing circuitry that is configured to generate a virtual effect in a virtual scene, the virtual effect being configured to change an attribute value of a virtual object that is located within a functional range of the virtual effect. The processing circuitry is configured to determine, based on positional relationships between a plurality of body parts of the virtual object and the virtual effect in the virtual scene, a sub-attribute change value for each of the plurality of body parts of the virtual object that is affected by the virtual effect. The processing circuitry is configured to determine a change to the attribute value of the virtual object based on the sub-attribute change value of each of the plurality of body parts of the virtual object that is affected by the virtual effect.

According to another aspect, an apparatus is provided. The apparatus includes processing circuitry that is configured to display a second virtual object, the second virtual object including a plurality of object parts, and the second virtual object being a virtual object mainly controlled by a current terminal. The processing circuitry is configured to display a virtual prop thrown into a virtual scene, the virtual prop being used for triggering a specified function within a functional range after being thrown into the virtual scene, and the specified function being used for exerting an influence on an attribute value of a virtual object located in the functional range. The processing circuitry is configured to display the specified function of the virtual prop triggered within the functional range. The processing circuitry is configured to display an attribute influence result of the second virtual object in response to the second virtual object being located in the functional range, the attribute influence result being a result obtained by integrating sub-attribute influence results respectively corresponding to the plurality of object parts, and the sub-attribute influence results being influence results respectively generated by the plurality of object parts under the specified function.

According to another aspect, a computer device is provided. The computer device includes a processor and a memory. The memory stores at least one instruction, at least one program, and a code set or an instruction set, and the at least one instruction, the at least one program, the code set or the instruction set is loaded and executed by the processor to perform the virtual object display method in any of the embodiments of this disclosure.

According to another aspect, a non-transitory computer-readable storage medium is provided. The non-transitory computer-readable storage medium stores instructions which when executed by a processor cause the processor to perform the method in any of the embodiments of this disclosure.

According to another aspect, a computer program product or a computer program is provided. The computer program product or computer program includes computer instructions, and the computer-readable instructions are stored in a computer-readable storage medium. A processor of a computer device reads the computer instructions from the computer-readable storage medium and executes the computer instructions, causing the computer device to perform the method in any of the embodiments of this disclosure.

Examples of beneficial effects of the technical solutions provided by the embodiments of this disclosure include:

The second virtual object includes the plurality of object parts. When the specified function of the virtual prop thrown into the virtual scene is triggered within the functional range, if the second virtual object is located in the functional range, the virtual prop exerts influences respectively on the plurality of object parts of the second virtual object, thereby obtaining the plurality of sub-attribute influence result. Finally, the attribute influence result of the virtual prop on the second virtual object is determined by integrating the plurality of sub-attribute influence results. By subdivision of the attribute influence result of the virtual prop on the second virtual object, the fine granularity of the attribute influence result is improved, so that a player can exert an attribute influence on the second virtual object after throwing the virtual prop at various different positions, and the player will not adjust a throwing position for many times, which reduces overheads of a computer for position calculation.

### BRIEF DESCRIPTION OF THE DRAWINGS

FIG. 1 is a schematic diagram of a process of a virtual object display method according to one exemplary embodiment of this disclosure.

FIG. 2 is a schematic diagram of an implementation environment according to one exemplary embodiment of this disclosure.

FIG. 3 is a flowchart of a virtual object display method according to one exemplary embodiment of this disclosure.

FIG. 4 is a schematic diagram of a specified range according to one exemplary embodiment of this disclosure.

FIG. 5 is a schematic diagram of a specified range according to another exemplary embodiment of this disclosure.

FIG. 6 is a schematic diagram of a specified range according to another exemplary embodiment of this disclosure.

FIG. 7 is a schematic diagram of an attribute value box according to one exemplary embodiment of this disclosure.

FIG. 8 is a schematic diagram of a virtual character identifier according to one exemplary embodiment of this disclosure.

FIG. 9 is a flowchart of a virtual object display method according to another exemplary embodiment of this disclosure.

FIG. 10 is a schematic diagram of an interface of an obstacle existing between a first object part and a virtual prop according to one exemplary embodiment of this disclosure.

FIG. 11 is a flowchart of a virtual object display method according to another exemplary embodiment of this disclosure.

FIG. 12 is a schematic diagram of an interface of bone point connecting lines according to one exemplary embodiment of this disclosure.

FIG. 13 is a schematic diagram of a projection of a second virtual object in a functional range according to one exemplary embodiment of this disclosure.

FIG. 14 is a schematic diagram of a projection of a second virtual object in a functional range according to another exemplary embodiment of this disclosure.

FIG. 15 is a schematic diagram of a projection of a second virtual object in a functional range according to another exemplary embodiment of this disclosure.

FIG. 16 is a flowchart of a virtual object display method according to another exemplary embodiment of this disclosure.

FIG. 17 is a schematic diagram of projections of different postures according to one exemplary embodiment of this disclosure.

FIG. 18 is a flowchart of a virtual object display method according to another exemplary embodiment of this disclosure.

FIG. 19 is a schematic diagram of first-aid effect identifier and a first-aid range identifier according to one exemplary embodiment of this disclosure.

FIG. 20 is a complete flowchart of a virtual object display method according to one exemplary embodiment of this disclosure.

FIG. 21 is a schematic diagram of an interface of a virtual object display method according to one exemplary embodiment of this disclosure.

FIG. 22 is a schematic diagram of an interface of a virtual object display method according to another exemplary embodiment of this disclosure.

FIG. 23 is a schematic diagram of a projection plane according to another exemplary embodiment of this disclosure.

FIG. 24 is a structural block diagram of a virtual object display apparatus according to one exemplary embodiment of this disclosure.

FIG. 25 is a structural block diagram of a virtual object display apparatus according to another exemplary embodiment of this disclosure.

FIG. 26 is a structural block diagram of a virtual object display apparatus according to another exemplary embodiment of this disclosure.

FIG. 27 is a structural block diagram of a computer device according to one exemplary embodiment of this disclosure.

### DESCRIPTION OF EMBODIMENTS

Exemplary applications of a virtual object display method provided by embodiments of this disclosure to a game scene will be explained below: A shooting game is taken as an example. In the game, virtual character A and virtual character B are in an adversarial relationship. When virtual character B throws a virtual grenade prop next to virtual character A, an explosion damage of the virtual grenade may be triggered. In this case, a game interface of virtual character A may display an explosion animation of the virtual grenade. At the same time, a server may calculate a specific explosion damage to virtual character A according to a position of virtual character A in a virtual scene and a position of the virtual grenade prop in the virtual scene when it is exploded.

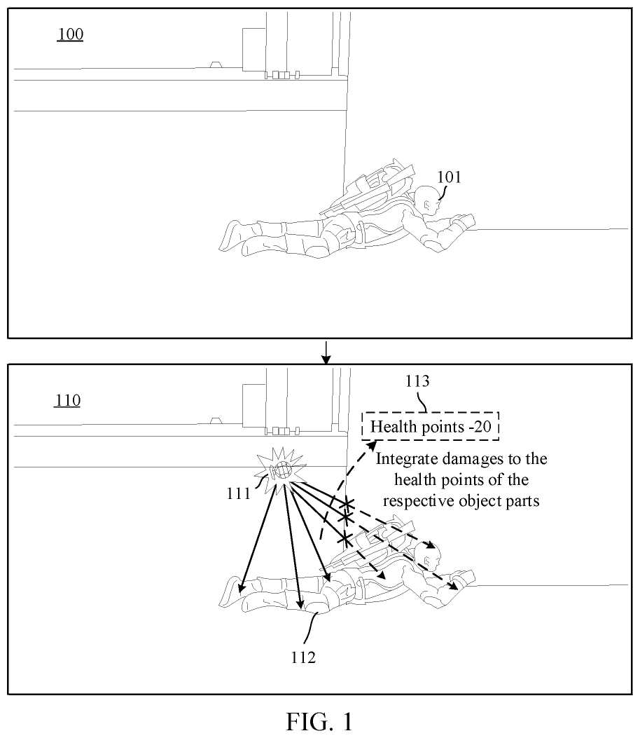

Referring to FIG. 1, in game interface 100, a second virtual object is a virtual character 101. The virtual character 101 includes multiple body parts, for example: the hands, the feet, the head, the waist, the abdomen, and the chest. When a virtual grenade prop is thrown at the vicinity of the virtual character 101, an explosion animation of a virtual grenade 111 is displayed in game interface 110. At this time, since a virtual character 112 (which is the same virtual character as the virtual character 101) is within an explosion range of the virtual grenade 111, the virtual grenade 111 may cause damage to the virtual character 112. A mechanism of causing damage is as follows: A total damage value on the virtual character 112 is determined by integrating or summing sub-damage values of the virtual grenade 111 on the respective body parts of the virtual character 112, and a damage value of the virtual grenade 111 on each body part is calculated separately. The total damage value 113 of the virtual grenade 111 on the virtual character 112 may be displayed in game interface 110 in some examples.

FIG. 2 is a schematic diagram of an implementation environment according to one exemplary embodiment of this disclosure. As shown in FIG. 2, the implementation environment includes a terminal 201, a terminal 202, and a server 210. The first terminal 201 and the server 210 are connected through a communication network 220. The second terminal 202 and the server 210 are connected through the communication network 220.

A first application program 203 that supports a virtual scene is installed and run in the first terminal 201. In an example, a first account corresponding to a second virtual object is logged in to the first terminal 201. When the first terminal 201 runs the first application program 203, the virtual scene of the first application program 203 is displayed on a screen of the first terminal 201, and the first terminal 201 can control the second virtual object. A second application program 204 that supports a virtual scene is installed and run in the second terminal 202. In an example, a second account corresponding to a first virtual object is logged in to the second terminal 202. When the second terminal 202 runs the second application program 204, the virtual scene of the second application program 204 is displayed on a screen of the second terminal 202, and the second terminal 202 can control the first virtual object. In some embodiments, if the first application program 203 run in the first terminal 201 and the second application program 204 run in the second terminal 202 are the same application program, the second virtual object and the first virtual object can be displayed in the same virtual scene. The first application program 203 and the second application program 204 may be any one of a virtual reality application program, a first-person shooting (FPS) game, a third-person shooting (TPS) game, a multiplayer online Battle Arena (MOBA) game, a Massive Multiplayer Online Role-Playing Game (MMORPG), and the like. The embodiments of this disclosure do not limit this.

In an example, each of the first application program 203 and the second application program 204 provides a control function for a virtual prop and a display function for virtual objects. Implementation of the first application program 203 and the second application program 204 as the same first-person shooting game and implementation of the virtual prop as a virtual grenade prop are taken as an example for explanation. The first account and the second account are in the same game battle, and the first account and the second account belong to an adversarial relationship, as shown in FIG. 2:

(1) Throwing operation performed on the virtual grenade prop. The virtual grenade prop is provided in a virtual scene 205 of the first-person shooting game currently run in the second terminal 202. The second terminal 202 receives a throwing operation performed on the virtual grenade prop and sends the throwing operation to the server 210. The server 210 receives the throwing operation performed on the virtual grenade prop and may feed back rendering data of a first throwing interface to the first terminal 201 and feed back rendering data of a second throwing interface to the second terminal 202. The second terminal 202 receives the rendering data of the second throwing interface and displays a virtual scene 206 on an interface of the second terminal 202. An animation of the grenade being thrown out and an explosion animation triggered by the grenade are displayed in the virtual scene 206.

(2) Attribute influence result display request. The first terminal 201 receives the rendering data of the first throwing interface, and displays the virtual scene 207 on the interface of the first terminal 201. The explosion animation triggered by the grenade is displayed in the virtual scene 207. Meanwhile, the first terminal 201 sends an attribute influence result display request to the server 210, where the attribute influence result display request includes position data of the second virtual object and position data of the virtual grenade prop at this time.

The server 210 receives the attribute influence result display request and may be configured to: obtain a functional range corresponding to the virtual grenade prop and determine, according to the position data of the second virtual object and the position data of the virtual grenade prop at this time, whether the second virtual object is within an explosion range of the virtual grenade prop; if the second virtual object is within the explosion range of the virtual grenade prop, obtain damage data of the virtual grenade prop on a plurality of object parts of the second virtual object; finally, obtain total damage data of the virtual grenade prop on the second virtual object by integrating the damage data of the virtual grenade prop on the plurality of object parts of the second virtual object, and obtain attribute influence result display data of the second virtual object on the basis of the total damage data; and send the attribute influence result display data to the first terminal 201. The first terminal 201 receives the attribute influence result display data and displays a picture 208 showing a decrease in health points of the second virtual object.

In an example, the first terminal 201 and the second terminal 202 are, but are not limited to, smartphones, tablets, desktop computers, portable laptops, smart appliances, vehicle-mounted terminals, and aircrafts. In some embodiments, the server 210 is configured to provide backend services for the application programs installed in the first terminal 201 and the second terminal 202. It is worth noting that the server 210 may be an independent physical server, or may be a server cluster or a distributed system formed by a plurality of physical servers, or may be a cloud server that provides basic cloud computing services such as cloud services, cloud databases, cloud computing, cloud functions, cloud storage, network services, cloud communication, middleware services, domain name services, security services, Content Delivery Networks (CDNs), big data, and artificial intelligence platforms. In some embodiments, the communication network 220 may be a wired network or a wireless network. The embodiments of this disclosure do not limit this.

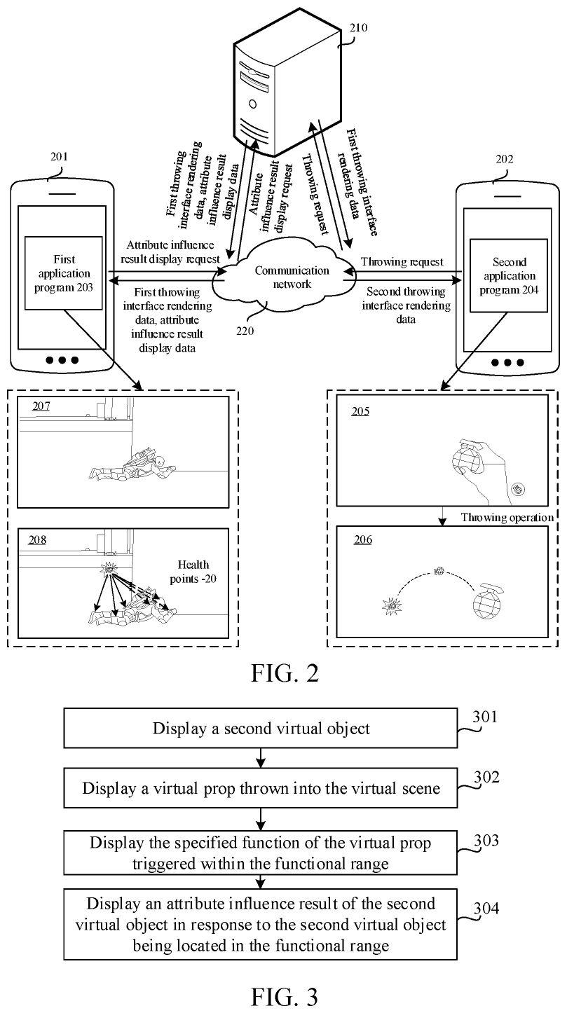

Based on the above introduction and implementation environment, a first virtual object throws a virtual prop in a virtual scene, which is taken as an example. FIG. 3 is a flowchart of a virtual object display method according to an embodiment of this disclosure. Application of the method to the terminals as shown in FIG. 2 is taken as an example for explanation. The method includes:

Step 301: Display a second virtual object.

The second virtual object includes a plurality of object parts, and the second virtual object is a virtual object mainly controlled by a current terminal. In an example, an application program is installed and run in the current terminal, and a first account is logged in on the application program. The application program is an application program that supports a virtual scene. A virtual scene is a scene displayed when a target application program is run in a terminal. In an example, the virtual scene further includes at least one of a virtual sky, a virtual land, a virtual ocean, and the like. The virtual land includes environmental elements such as deserts and cities. Implementation of the application program as a first-person shooting game is taken as an example for explanation. The second virtual object may be a virtual character in a virtual scene controlled by the first account, or a virtual vehicle in a virtual scene controlled by the first account. Object parts refer to partial structures of the second virtual object, and the second virtual object includes the plurality of object parts. If the second virtual object is the virtual character, the plurality of object parts include at least one of the left arm, the right arm, the left leg, the right leg, the head, the chest, the abdomen, and the like of the virtual character. If the second virtual object is the virtual vehicle, the plurality of object parts include at least one of a vehicle body, wheels, an engine, a fuel tank, and the like of the virtual vehicle.

In an example, a quantity of the plurality of object parts included in the second virtual object is greater than or equal to 2, which means that the second virtual object is composed of at least two object parts. If the second virtual object is the virtual character, the virtual character is at least composed of an upper part of the body and the lower part of the body. In an example, the first account can control the second virtual object to move in the virtual scene, for example: walking, running, jumping, squatting, standing up, flying, gliding, and the like. The first account can control the second virtual object to release a skill in the virtual scene, for example: boxing, shooting, throwing, switching of props, reloading, and the like.

Step 302: Display a virtual prop thrown into the virtual scene.

The virtual prop is used for triggering a specified function within a functional range after being thrown into the virtual scene, and the specified function is used for exerting an influence on an attribute value of a virtual object located in the functional range.

The attribute value includes: at least one of health points, an energy value, attack power, an attack speed, a moving speed, and the like, which is not limited in the embodiments of this disclosure. In an example, the virtual scene further includes a first virtual object controlled by a second account. The second account is an account logged in on the application program of the second terminal. The second account may be an account that has an adversarial relationship with the first account, or the second account may be an account that has a cooperative relationship with the first account. Implementation of the application program as a first-person shooting game is taken as an example for explanation. The first account and the second account are in the same team and cooperate with each other for fighting. Or, the first account and the second account belong to different teams and are in the adversarial relationship. In an example, the virtual prop is a prop thrown by the second virtual object into the virtual scene, or the virtual prop is a prop thrown by the first virtual object into the virtual scene. The embodiments of this disclosure do not limit this. In an example, the virtual prop is thrown onto the ground in the virtual scene. Or, the virtual prop is thrown into the sky in the virtual scene. Or, the virtual prop is thrown onto the body of a virtual object.

The specified function refers to a functional effect exerted when the virtual prop is triggered. The specified function may include at least one of the following:

1. The specified function is used for generating a debuff effect on an attribute value of a virtual object located in the functional range.

The virtual prop may be implemented as a virtual grenade prop. When the virtual grenade prop triggers an explosion effect, that is, the specified function, the attribute value of the virtual object within an explosion range of the virtual grenade prop will have a debuff, for example: a decrease in the health points, a blocked view, hearing loss, a decrease in the moving speed, slowdown of the attack speed, a decrease in the critical chance, and the like, so that the game progress can be accelerated, a game duration can be shortened, and the computer overheads are reduced.

2. The specified function is used for generating a buff effect on an attribute value of a virtual object located in the functional range.

The virtual prop may be implemented as a virtual first-aid prop. When the virtual first-aid prop triggers a first-aid effect, that is, the specified function, the attribute value of the virtual object within a first-aid range of the virtual first-aid prop will have a gain, which can improve the combat ability of the virtual object, thereby accelerating the game rhythm and improving the human-computer interaction efficiency.

3. The specified function is also used for restricting actions of a virtual object located in the functional range.

The virtual prop may be implemented as a virtual anesthesia prop. When the virtual anesthesia prop triggers an anesthesia effect, that is, the specified function, the virtual object within an anesthesia range of the virtual anesthesia prop can neither move in the virtual scene nor release any skills. In an example, the virtual anesthesia prop corresponds to anesthesia time, and the anesthesia effect includes at least one of the following situations: Situation I: Timing starts when the virtual anesthesia prop is triggered. Within the anesthesia time, the influence of the anesthesia effect on the virtual object is fixed and unchanged. Situation II: Timing starts when the virtual anesthesia prop is triggered. Within the anesthesia time, the influence of the anesthesia effect on the virtual prop is gradually reduced. For example: The trigger time of the virtual anesthesia prop is 0 second, and the anesthesia time is 2 seconds. From 0^{th} second to the 1^{st} second, the virtual object is completely unable to move or release any skills. From the 1^{st} second to the 2^{nd} second, the virtual object regains its walking and moving ability, and can release simple skills (for example: boxing). After the 2^{nd} second, the virtual object returns to a state before anesthesia. Situation III: Timing starts when the virtual anesthesia prop is triggered. Within the anesthesia time, the influence of the anesthesia effect on the virtual prop is gradually enhanced. For example: The trigger time of the virtual anesthesia prop is 0 second, and the anesthesia time is 2 seconds. From the 0^{th} second to the 1^{st} second, the virtual object cannot run, move, and use a prop skill (for example: using a virtual drug to refill the health points). From the 1^{st} second to the 2^{nd} second, the virtual object is completely unable to move or release any skills. After the 2^{nd} second, the virtual object returns to a state before anesthesia. A computer can only perform picture rendering on the position of the virtual object within this time period, with a small rendering volume, thereby improving the rendering accuracy.

4. The specified function is also used for changing a representation of a virtual object located in the functional range.

The virtual prop may be implemented as a virtual transformation prop. When the virtual transformation prop triggers a transformation effect, that is, the specified function, the virtual object within a transformation range of the virtual transformation prop may change its representation in the virtual scene. That is, transformation using a virtual prop can cause a computer to directly render a transformation picture of the virtual object holding the virtual prop, which improves the pertinence of rendering.

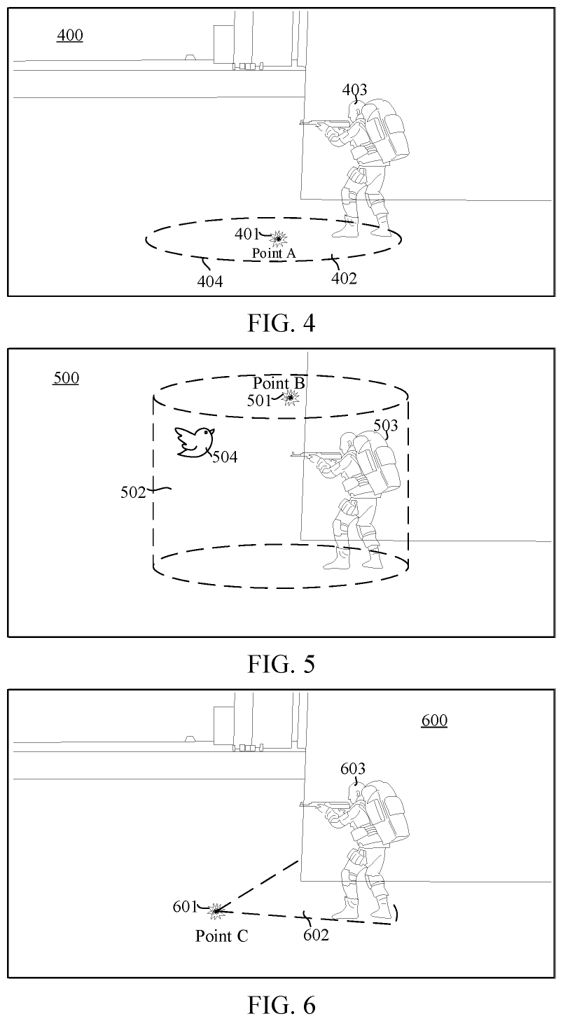

In an example, the functional range refers to a range that can be influenced by the specified function triggered by the virtual prop in the virtual scene, and the functional range includes at least one of the following ranges: 1. A circle range taking a position triggered by the virtual prop as a circle center and taking a preset distance as a radius is the functional range of the virtual prop. As shown in FIG. 4, in a virtual scene 400, if a position triggered by a virtual prop 401 is point A on the ground, a functional range of the virtual prop 401 is a circle 402. If a virtual object 403 is within the circle 402, the virtual object 403 is within the functional range of the virtual prop 401. 2. An interior of a cylinder taking a position triggered by the virtual prop as a circle center, taking a first preset distance as a radius and taking a second preset distance as a height is the functional range of the virtual prop.

As shown in FIG. 5, in a virtual scene 500, if a position triggered by a virtual prop 501 is point B in the sky, a functional range of the virtual prop 501 is an interior of a cylinder 502. Therefore, a second virtual object 503 on the ground and a first virtual object 504 in the sky are both located within the functional range of the virtual prop 501. 3. A sector range taking a position triggered by the virtual prop as a circle center, taking a preset angle as a central angle and taking a preset distance as a radius is the functional range of the virtual prop. As shown in FIG. 6, in a virtual scene 600, if a position triggered by a virtual prop 601 is point C on the ground, a functional range of the virtual prop 601 is a sector 602. If a virtual object 603 is within the sector 602, the virtual object 603 is within the functional range of the virtual prop 601. In some embodiments, the virtual scene also displays sub-attributes corresponding to the plurality of object parts of the second virtual object, that is, each object part of the second virtual object has a corresponding attribute, for example: health points.

Step 303: Display the specified function of the virtual prop triggered within the functional range.

In an example, when the virtual prop triggers the specified function, a specified animation is displayed within the functional range, and the specified animation matches the specified function. When the virtual grenade prop triggers an explosion damage, an explosion animation is displayed within the functional range.

In an example, the position triggered by the virtual prop is a position to which the virtual prop is thrown. Or, the position triggered by the virtual prop is not a position to which the virtual prop is thrown. The position triggered by the virtual prop is possibly not the position to which the virtual prop is thrown. Specifically, when a virtual object throws the virtual prop onto the ground in the virtual scene, it can be considered that the virtual prop is thrown to a position of a landing point. The landing point is the position to which the virtual prop is thrown. However, if the virtual prop is not a prop that is triggered immediately after the prop lands, the virtual prop may move forward a certain distance before being triggered. In this case, a trigger position of the virtual prop and the position to which the virtual prop is thrown are not the same.

In an example, the above specified function is triggered in at least one of the following ways:

1. When the virtual prop is thrown to a specified position, the specified function is triggered.

For example, a first virtual character throws a virtual grenade prop into the virtual scene. When the virtual grenade prop comes into contact with the ground in the virtual scene, an explosion damage is triggered immediately. Or, the first virtual character throws the virtual grenade prop to the body of a second virtual character. When the virtual grenade prop comes into contact with the second virtual character, the explosion damage is triggered immediately.

2. The virtual prop correspondingly has the trigger time. When the virtual prop is thrown out, timing starts. The specified function is triggered at the trigger time.

For example, the trigger time of the virtual grenade prop is 3 seconds. At the 0^{th} second, the first virtual character throws out the virtual grenade prop, and at the third second, the virtual grenade prop triggers an explosion damage.

3. After the virtual prop is thrown into the virtual scene, a virtual object selects whether to trigger the specified function. For example, the first virtual character throws the virtual grenade prop onto the ground in the virtual scene. When the first virtual character clicks an explosion button, the virtual grenade prop triggers an explosion damage. Or, if the second virtual character steps on the virtual grenade prop, the virtual grenade prop triggers the explosion damage.

In some embodiments, a functional range identifier is also displayed in the virtual scene. As shown in FIG. 4, if the functional range of the virtual prop 401 is the circle 402, a functional range identifier is a circumference 404. If the virtual prop 401 is thrown onto the ground but has not yet been triggered, the circumference 404 can be highlighted to remind the virtual object 403 of the functional range of the virtual prop 401.

Step 304: Display an attribute influence result of the second virtual object in response to the second virtual object being located in the functional range.

The attribute influence result is a result obtained by integrating sub-attribute influence results respectively corresponding to the plurality of object parts, and the sub-attribute influence results are influence results respectively generated by the plurality of object parts under the specified function.

In some embodiments, the second virtual object corresponds to an object identification point. The object identification point represents the second virtual object. When the object identification point is within the functional range, it represents that the second virtual object is located in the functional range. Specifically, the above object identification point is a center bone point of the second virtual object. The center bone point of the second virtual object is within the functional range. In some embodiments, the second virtual object includes a plurality of object parts, and the plurality of object parts correspondingly have object part bone points respectively. When at least one object part bone point is within the functional range, it represents that the second virtual object is located in the functional range. For example, when a head bone point of the second virtual object is within the functional range, it represents that the second virtual object is located in the functional range.

In some embodiments, a fusion result of the sub-attribute influence results respectively corresponding to the plurality of object parts is displayed as the attribute influence result of the second virtual object. Or, the sub-attribute influence results corresponding to the plurality of object parts are separately displayed as the attribute influence result of the second virtual object. In an example, if the sub-attribute influence results corresponding to the plurality of object parts are separately displayed as the attribute influence result of the second virtual object, the above step of displaying the attribute influence result of the second virtual object further includes the following: First, in response to the second virtual object being located in the functional range, a first sub-attribute influence result of the first object part is displayed in a case that a first object part of the second virtual object and the virtual prop are in a first positional relationship. In an example, in response to the second virtual object being located in the functional range, the sub-attribute influence result of the first object part avoiding the specified function is displayed in a case that an obstacle exists between a first object part of the second virtual object and the virtual prop. For example, when the virtual grenade prop is exploded, if a virtual character is within the explosion range and an obstacle exists between the left arm of the virtual character and the virtual prop, a picture showing that the left arm of the virtual character has not been attacked is displayed, for example: a picture showing that the left arm of the virtual character remains stationary, that is, the left arm of the virtual character avoids the influence exerted by the explosion of the virtual grenade prop. Second, in response to the second virtual object being located in the functional range, a second sub-attribute influence result of the second object part is displayed in a case that a second object part of the second virtual object and the virtual prop are in a second positional relationship. The second positional relationship means that no obstacle exists between the object part and the virtual prop. In an example, the sub-attribute influence result of the second object part under the influence of the specified function, such as an attribute influence function, is displayed in a case that through connection is achieved between a second object part among the plurality of object parts and the virtual prop.

Displaying of the attribute influence result includes at least one of the following situations:

1: Display an attribute value change result of the second virtual object as the attribute influence result.

The attribute value change result is displayed in at least one of the following ways: Way I: Directly display an attribute value change number. For example, when a virtual character is located in the explosion range of the virtual grenade prop, if the virtual grenade prop causes a decrease of 20 health points to the left arm of the virtual character, a decrease of 10 health points to the right arm of the virtual character, and a decrease of 30 health points to the head of the virtual character, but does not cause a decrease of health points to the left leg, right leg, abdomen, and chest of the virtual character, the virtual grenade prop causes a decrease of 60 health points (namely, the attribute influence result) to the virtual character, and a number prompt of “HP −60” will be displayed around the virtual character. Way II: Display a changed attribute value box.

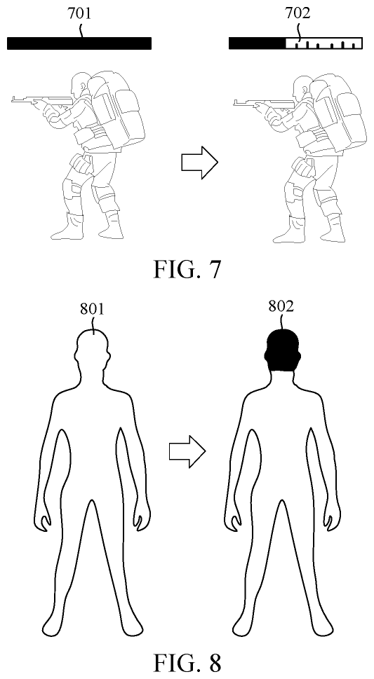

In an example, as shown in FIG. 7, when the virtual character is not influenced by the explosion damage of the virtual grenade prop, the black filled region in a health point bar 701 corresponding to the virtual character is 100%, indicating that the virtual character has 100 health points. When a virtual character is located in the explosion range of the virtual grenade prop, if the virtual grenade prop causes a decrease of 20 health points to the left arm of the virtual character, a decrease of 10 health points to the right arm of the virtual character, and a decrease of 30 health points to the head of the virtual character, but does not cause a decrease of health points to the left leg, right leg, abdomen, and chest of the virtual character, the virtual grenade prop causes a decrease of 60 health points (namely, the attribute influence result) to the virtual character. In this case, the black filled region in a health point bar 702 corresponding to the virtual character is 40%, indicating that the virtual character has 40 health points at this time. It is worth noting that when the second virtual object is located in the functional range, only the attribute value change number may be displayed, or only the changed attribute value box may be displayed, or both the attribute value change number and the changed attribute value box may be displayed.

2: Display an appearance change result of the second virtual object as the attribute influence result.

The appearance change result is displayed in at least one of the following ways: Way I: Directly display the appearance change result of the second virtual object. In an example, an appearance of the second virtual object is displayed on the basis of an attribute value of the second virtual object. For example, when the head of a virtual character has 100 health points, the head is displayed normally. When the head of the virtual character has 50 health points, the head is displayed as being injured. In an example, the above displaying as being injured correspondingly has an injury level. Different injury levels correspond to different degrees of displaying as being injured. The health point of the second virtual object corresponding to a first injury level is [0, 10). The health point of the second virtual object corresponding to a second injury level is [10, 50). The health point of the second virtual object corresponding to a third injury level is [50, 100). For example, when a virtual character is not influenced by the explosion damage of the virtual grenade prop, all the parts of the virtual character are displayed normally, that is, all the parts have 100 health points. When the virtual character is located in the explosion range of the virtual grenade prop, if the virtual grenade prop causes a decrease of 20 health points to the left arm of the virtual character, the left arm at the third injury level is displayed; if the virtual grenade prop causes a decrease of 10 health points to the right arm of the virtual character, the right arm at the third injury level is displayed; if the virtual grenade prop causes a decrease of 60 health points to the head of the virtual character, the head at the second injury level is displayed; and if the virtual grenade prop causes no decrease in the health points to the left leg, right leg, abdomen, and chest of the virtual character, the left leg, right leg, abdomen, and chest of the virtual character are still displayed normally. Way II: Display a change result of an appearance identifier of the second virtual object. In an example, displaying of the appearance identifier of the second virtual object corresponds to displaying of the appearance of the second virtual object. For example, as shown in FIG. 8, when a virtual character is not influenced by the explosion damage of the virtual grenade prop and all the parts of the virtual character has 100 health points, a virtual character identifier 801 only displays a contour of the virtual character and is not filled with any color, indicating that the health points of the virtual character have not been decreased yet. When the virtual character is located in the explosion range of the virtual grenade prop, if a decrease of 20 health points to the head of the virtual character, a red sign flashes on the head of the virtual character identifier 802 to indicate that the head of the virtual character identifier 802 has been damaged. If a decrease of 91 health points to the head of the virtual character, a red sign is directly displayed on the head of the virtual character identifier 802 to indicate that the head gets seriously injured at this time. In an example, the virtual character will die within 10 seconds in this case.

The second virtual object includes the plurality of object parts. When the specified function of the virtual prop thrown into the virtual scene is triggered within the functional range, if the second virtual object is located in the functional range, the virtual prop exerts influences respectively on the plurality of object parts of the second virtual object, thereby obtaining the plurality of sub-attribute influence result. Finally, the attribute influence result of the virtual prop on the second virtual object is determined by integrating the plurality of sub-attribute influence results. By subdivision of the attribute influence result of the virtual prop on the second virtual object, the fine granularity of the attribute influence result is improved, so that the accuracy of exerting an influence by the virtual prop on the virtual object is improved.

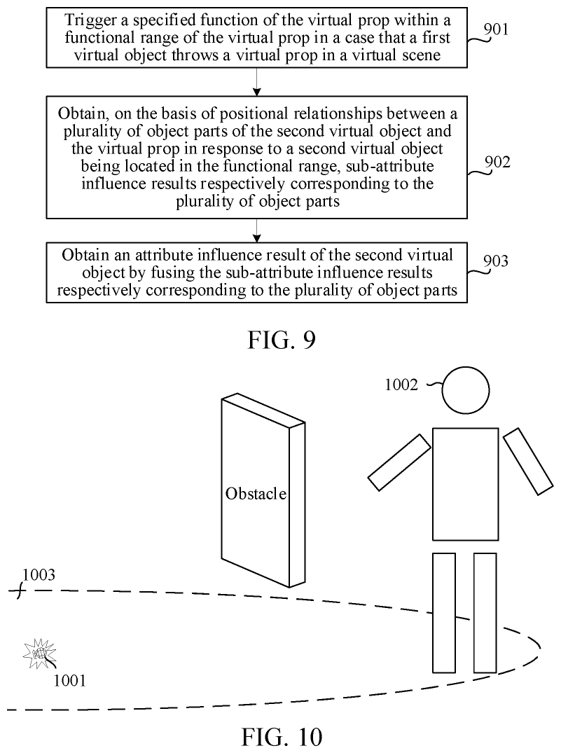

FIG. 9 is a flowchart of a virtual object display method according to an embodiment of this disclosure. The method may be applied to the terminals as shown in FIG. 2, or may be applied to the server as shown in FIG. 2. Application of the method to the server as shown in FIG. 2 is taken as an example for explanation. The method includes:

Step 901: Trigger a specified function of the virtual prop within a functional range of the virtual prop in a case that a first virtual object throws a virtual prop in a virtual scene. In an example, a virtual effect is generated in the virtual scene, the virtual effect being configured to change an attribute value of a virtual object that is located within a functional range of the virtual effect.

In some embodiments, the specified function is an instantaneous function, which means that the specified function will exert an influence on a virtual object within the functional range at the moment of triggering, and will not exert an influence after the triggering ends. In some embodiments, the specified function is a sustained function, which means that the specified function will exert an influence on a virtual object within the functional range for a continuous period of time, and the specified function will fail after the period of time. In an example, when the specified function is the sustained function, the specified function includes a first stage function and a second stage function. Influences exerted by the first stage function and the second stage function are different. For example, the implementation of the virtual prop as a virtual grenade prop is taken as an example for explanation. The virtual grenade prop generates first stage damage during explosion, namely, the first stage function. The first stage damage lasts for 1 second. Within the 0^{th} second to the 1^{st} second of the explosion of the virtual grenade prop, the virtual object within the explosion range may suffer the first stage damage, usually a decrease in the health points. After 1 second of explosion, the virtual grenade prop can generate the second stage damage, which lasts for 2 seconds. If the virtual object does not leave the explosion range at the 2^{nd} second, the virtual object may suffer the second stage damage, which is the second stage function. The second stage damage may be a small decrease in the health points, or the second stage damage can slow down the virtual object, make the virtual object fail in skills, drop equipment of the virtual object (in this state, the virtual object is unable to pick up the dropped equipment), and the like. It is worth noting that an explosion effect of the virtual grenade prop persists. If another virtual object enters the explosion range at the 2^{nd} second of the explosion, the virtual object may suffer the second stage damage.

Step 902: Obtain, on the basis of positional relationships between a plurality of object parts of the second virtual object and the virtual prop in response to a second virtual object being located in the functional range, sub-attribute influence results respectively corresponding to the plurality of object parts. In an example, based on positional relationships between a plurality of body parts of the virtual object and the virtual effect in the virtual scene, a sub-attribute change value for each of the plurality of body parts of the virtual object that is affected by the virtual effect is determined.

The sub-attribute influence results are influence results respectively generated by the plurality of object parts under the specified function.

In an example, the above second virtual object is a virtual object within the functional range of the virtual prop. When the explosion effect of the virtual grenade prop is triggered, if a virtual character is within the explosion range, it is necessary to analyze a positional relationship between each body part of the virtual character and the virtual prop to obtain injury conditions of a plurality of body parts of the virtual character. In some embodiments, each of the above positional relationship include a first positional relationship and a second positional relationship. The first positional relationship indicates that an obstacle exists between the virtual prop and an object part. The second positional relationship indicates that no obstacle exists between the virtual prop and the object part.

As shown in FIG. 10, when a current virtual grenade prop 1001 is exploded on the ground and a virtual character 1002 is within an explosion range 1003, it is determined whether an obstacle exists between each of a plurality of body parts of the virtual character 1002 and the virtual grenade prop. If an obstacle exists, the body part and the virtual grenade prop have the first positional relationship; and is no obstacle exists, the body part and the virtual grenade prop have the second positional relationship.

Step 903: Obtain an attribute influence result of the second virtual object by fusing the sub-attribute influence results respectively corresponding to the plurality of object parts. In an example, a change to the attribute value of the virtual object is determined based on the sub-attribute change value of each of the plurality of body parts of the virtual object that is affected by the virtual effect.

In some embodiments, the attribute influence result of the second virtual object is obtained in at least one of the following ways: 1: Obtain the attribute influence result of the second virtual object by performing summation of the sub-attribute influence results respectively corresponding to the plurality of object parts. 2: Obtain the attribute influence result of the second virtual object by performing weighted summation on the sub-attribute influence results respectively corresponding to the plurality of object parts. In an example, the sub-attribute influence results correspond to weight coefficients. The weight coefficients have a value interval of [0,1), and a sum of the weight coefficients of the plurality of object parts has a value interval of (0,1]. That is, the overall attribute influence result of the second virtual object is obtained by calculating the sub-attribute influence results respectively corresponding to the plurality of object parts in different calculation ways, which can improve the authenticity of the overall attribute influence result.

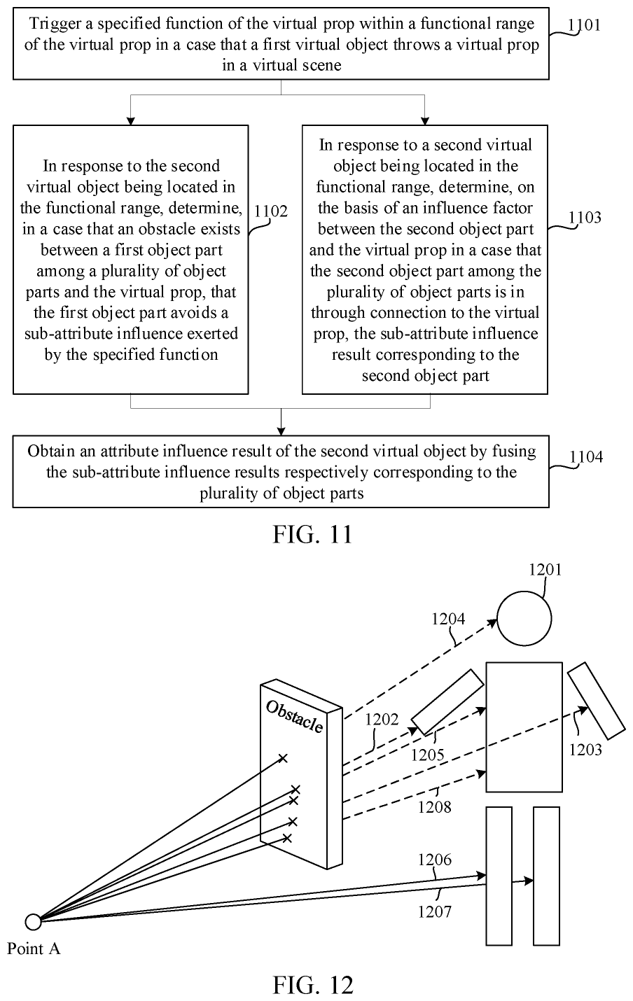

FIG. 11 is a flowchart of a virtual object display method according to an embodiment of this disclosure. The method may be applied to the terminals as shown in FIG. 2, or may be applied to the server as shown in FIG. 2. Application of the method to the server as shown in FIG. 2 is taken as an example for explanation. The method includes:

Step 1101: Trigger a specified function of the virtual prop within a functional range of the virtual prop in a case that a first virtual object throws a virtual prop in a virtual scene.

Step 1102: In response to the second virtual object being located in the functional range, determine, in a case that an obstacle exists between a first object part among a plurality of object parts and the virtual prop, that the first object part avoids a sub-attribute influence exerted by the specified function.

In an example, the above action that the first object part avoids the sub-attribute influence exerted by the specified function means that an influence exerted by the specified function of the virtual prop on a sub-attribute value generated by the first object part is 0. In some embodiments, the above method for determining that an obstacle exists between the object part and the virtual prop includes: creating bone point connecting lines respectively corresponding to the plurality of object parts from a position to which the virtual prop is thrown; and determining, in response to that the bone point connecting line corresponding to the first object part is blocked, that an obstacle exists between the first object part and the virtual prop. As shown in FIG. 12, a virtual character 1201 includes seven key body parts. The position to which the virtual grenade prop is thrown is point A. A bone point connecting line 1202 between point A and the left arm, a bone point connecting line 1203 between point A and the right arm, a bone point connecting line 1204 between point A and the head, a bone point connecting line 1205 between point A and the chest, a bone point connecting line 1206 between point A and the left leg, a bone point connecting line 1207 between point A and the right leg, and a bone point connecting line 1208 between point A and the abdomen are respectively created. The connecting lines 1202, 1203, 1204, 1205, and 1208 are blocked by obstacles, indicating that the obstacles exist between the left arm, right arm, head, chest, and abdomen of the virtual character 1201 and the virtual grenade prop.

In some embodiments, if the obstacle between the first object part and the virtual prop corresponds to an obstacle attribute, the process of determining the sub-attribute influence of the first object part further includes:

First: Obtain an obstacle attribute of the obstacle in a case that an obstacle exists between the first object part and the virtual prop.

In some embodiments, the obstacle includes a virtual wall for covering the first object part; and the obstacle attribute of the virtual wall includes an upper limit of wall damage coverage. For example, implementation of the upper limit of wall damage coverage as a current firmness value of the virtual wall is explained. The firmness value is used for indicating a firmness level of the virtual wall. If the firmness value is larger, it is harder to penetrate or damage the virtual wall.

Second: Determine an attribute influence of the specified function of the virtual prop on the obstacle attribute. In an example, the attribute influence of the specified function of the virtual prop on the obstacle attribute is determined according to a distance between the virtual prop and the obstacle. For example, implementation of the obstacle as the virtual wall body and implementation of the upper limit of wall damage coverage as the current firmness value of the virtual wall are taken as an example for explanation. Whether a distance between the virtual prop and the virtual wall is greater than a preset distance threshold; if the distance is greater than the preset distance threshold, the virtual prop cannot exert an influence on the firmness value; if the distance between the virtual prop and the virtual wall is less than or equal to the preset distance threshold, a distance coefficient corresponding to the distance between the virtual prop and the virtual wall is multiplied by a reference influence value of the virtual prop on the virtual wall, and an influence result of the specified function of the virtual prop on the firmness value of the virtual wall is calculated. The distance coefficient is determined on the basis of the distance between the virtual prop and the virtual wall and a specified distance base number. The specified distance base number is greater than 0 and less than 1, and a calculation formula for the distance coefficient is as follows: Formula I: Y=WD, where Y represents the distance coefficient; W represents a preset distance base number, W∈(0,1); and D represents the distance. In an example, the reference influence value of the virtual prop on the virtual wall is an influence exerted by the virtual prop on the firmness value of the virtual wall at a very short distance. A calculation formula for the influence result of the specified function of the virtual prop on the firmness value of the virtual wall body is: Formula II: E=Y*Z, where E represents the influence result; Y represents the distance coefficient; and Z represents the reference influence value.

Third: Determine, in response to that the specified function meets a penetration requirement for the attribute influence of the obstacle attribute, the sub-attribute influence exerted by the obstacle on the first object part under the influence of the specified function. That is, after the specified function meets the penetration requirement for the attribute influence of the obstacle attribute, the obstacle exerts a sub-attribute influence on the object part, which enriches the diversity of the attribute influence. In an example, when the obstacle is implemented as the virtual wall, in response to that an attack value of the specified function on the wall reaches the upper limit of wall damage coverage, the sub-attribute influence exerted by the wall on the first object part in a destroying and exploding process is determined. The attack value of the specified function on the wall is the influence result represented by E in Formula II, and the upper limit of wall damage coverage is the current firmness value of the virtual wall. If E is greater than or equal to the current firmness value of the virtual wall, the virtual wall may be exploded, and the exploded virtual wall can exert an influence on the first object part. The influence of the virtual wall on the first object part is determined according to an initial damage value of the virtual wall on the first object part and the distance between the virtual wall and the first object part. For example, the virtual wall corresponds to a wall grade. A higher grade indicates that the initial damage value of the virtual wall on the first object part is larger. The initial damage value is adjusted on the basis of the distance coefficient between the virtual wall and the first object part, and a calculation formula is as follows: Formula III: T=C*O^{P}, where T represents the adjusted initial damage value; C represents the initial damage value; O^{P} represents the distance coefficient between the virtual wall and the first object part; O represents an adjustment base number, O∈(0,1); and P represents the distance between the virtual wall and the first object part. T in Formula III represents the influence of the virtual wall on the first object part, that is, the sub-attribute influence of the obstacle on the first object part. That is, when the obstacle is the virtual wall that covers an object part, after the virtual wall is attacked by the virtual prop, the virtual wall can also exert the sub-attribute influence on the object part in the destroying and exploding process, which enriches the diversity of the attribute influence.

Step 1103: In response to a second virtual object being located in the functional range, determine, on the basis of an influence factor between the second object part and the virtual prop in a case that the second object part among the plurality of object parts is in through connection to the virtual prop, the sub-attribute influence result corresponding to the second object part.

The influence factor includes at least one of a distance factor, an armor factor, a projection relationship factor, a posture factor of a mainly controlled virtual object, a resistance factor, or a duration factor. In some embodiments, bone point connecting lines respectively corresponding to the plurality of object parts are created from a position to which the virtual prop is thrown; and it is determined that no obstacle exists between the second object part and the virtual prop in response to that the bone point connecting line corresponding to the second object part achieves through connection between the second object part and the virtual prop. For example, as shown in FIG. 12, a virtual character 1201 includes seven key body parts. The position to which the virtual grenade prop is thrown is point A. A bone point connecting line 1202 between point A and the left arm, a bone point connecting line 1203 between point A and the right arm, a bone point connecting line 1204 between point A and the head, a bone point connecting line 1205 between point A and the chest, a bone point connecting line 1206 between point A and the left leg, a bone point connecting line 1207 between point A and the right leg, and a bone point connecting line 1208 between point A and the abdomen are respectively created. The connecting lines 1206 and 1207 are blocked by obstacles, indicating that no obstacle exists between the left leg and right leg of the virtual character 1201 and the virtual grenade prop. That is, due to the method for creating the bone point connecting lines respectively corresponding to the plurality of object parts according to the throwing position of the virtual prop, whether an obstacle exists between an object part and the virtual prop is determined on the basis of a connection condition of the bone point connecting line, which can improve the accuracy of determining whether an obstacle exists between an object part and the virtual prop.

In some embodiments, the process of determining the sub-attribute influence result corresponding to the second object part further includes:

S1: In response to the second virtual object being located in the functional range, obtain, in a case that the second object part among the plurality of object parts is in through connection to the virtual prop, a reference attribute value corresponding to the second object part. In an example, the reference attribute value refers to a preset attribute influence result generated by the virtual prop on an object part in an ideal state. For example, the ideal state indicates that no obstacle exists between the virtual prop and the object part and a distance between the virtual prop and the object part is infinitely close to 0. Implementation of the virtual prop as a virtual grenade prop is taken as an example for explanation. When a position at which the virtual grenade prop is triggered is on a certain object part of a virtual object, a damage value of the virtual grenade prop to the object part is the reference damage value. In some embodiments, the reference attribute values of different object parts of the second virtual object are different. For example, in a shooting game, the reference damage values of the virtual grenade prop to the head and chest of a virtual character may be increased, while the reference damage values to the hands and feet of the virtual character may be decreased.

S2: Determine, on the basis of the influence factor between the second object part and the virtual prop, an adjustment coefficient for adjusting the reference attribute value.

The process of determining, on the basis of the above influence factor, the adjustment coefficient for adjusting the reference attribute value will be respectively explained below:

1. In a case that the influence factor includes the distance factor, a distance between the second object part and the virtual prop is taken as an exponential coefficient, and a product result of an adjustment base number under the exponential coefficient is taken as a first adjustment coefficient, where the adjustment base number is greater than 0 and less than 1. The first adjustment coefficient is used for adjusting the reference attribute value using a product result obtained after multiplication with the reference attribute value. If the influence factor includes the distance factor, for example, implementation of the virtual prop as the virtual grenade prop, implementation of the second virtual object as the virtual character, and implementation of the second object part as the head of the virtual character are taken as an example for explanation. A distance of the connecting line is obtained while the bone point connecting line from a coordinate point of explosion of the virtual grenade prop to the head of the virtual character. If the distance is greater than a distance threshold, a sub-attribute influence value exerted by the virtual grenade prop on the head of the virtual character is determined to be 0. If the distance is less than or equal to the distance threshold, it indicates that the virtual grenade prop can cause damage to the head of the virtual character. The distance and the adjustment base number are obtained at the same time, where the adjustment base number is greater than 0 and less than 1. The first adjustment coefficient is calculated using the adjustment base number serving as a base number coefficient and the distance serving as an exponential coefficient. A specific formula is as follows: Formula IV: X1=KL, where X1 represents the first adjustment coefficient; K represents the adjustment base number, K∈(0,1); and L represents the distance. In some embodiments, L in Formula IV above may also be implemented as a distance level. For example, the distance threshold of the virtual grenade prop is 12 meters. Distance level 1 means that the distance is within a range of (0 meter, 1 meter), and L in Formula I above is 1; distance level 2 means that the distance is within a range of (1 meter, 5 meters), and L in Formula I above is 2; distance level 3 means that the distance is within a range of (5 meter, 10 meters), and L in Formula I above is 3; and distance level 4 means that the distance is within a range of (10 meters, 12 meters), and L in Formula I above is 4. That is, due to the method for adjusting the reference attribute value using the first adjustment coefficient which is represented by the product result of the adjustment base number under the exponential coefficient that is represented by the distance between the object part and the virtual prop, an adjustment range of the reference attribute value can be an exponential range as the distance changes.

2. In a case that the influence factor includes the armor factor, a second adjustment coefficient is determined on the basis of a product result between an armor grade corresponding to the armor factor and the adjustment coefficient, where the adjustment coefficient is greater than 0 or equal to 1. The second adjustment coefficient is used for adjusting the reference attribute value using a product result obtained after multiplication with the reference attribute value. In some embodiments, the plurality of object parts of the second virtual object are also equipped with armors, and the armors have corresponding armor grades. For example, when playing a first-person shooting game, a virtual character can obtain a helmet, a bulletproof vest, and other props in the game. The helmet and the bulletproof vest correspond to grade numbers. A higher grade indicates that the helmet or the bulletproof vest has higher protection ability. If the influence factor includes the armor factor, it is necessary to first determine whether the second object part of the second virtual object is equipped with an armor. In an example, implementation of the virtual prop as a virtual grenade prop and implementation of the second object part as the head of a virtual character are taken as an example for explanation. When the virtual grenade prop is triggered, if the head of the virtual character is not equipped with a protection prop, such as a helmet, the influence factor does not include the armor factor. If the head of the virtual character is equipped with a helmet, a grade of the helmet and a preset coefficient are obtained at the same time. The preset coefficient is greater than 0 and less than 1. The grade of the helmet serves as the armor grade, and the preset coefficient serves as the adjustment coefficient, so that the second adjustment coefficient is calculated. A specific formula is as follows: Formula V: X2=1−G*Q, where X2 represents the second adjustment coefficient; Q represents the preset coefficient, Q∈(0,1); and G represents the armor grade. In some embodiments, the above armor grade will decrease with the number of times of use. For example, in a case of no attack, if the helmet is at grade 4, the armor grade is 4. If the helmet is attacked once, the grade of the helmet will decrease to 3, and the armor grade will be 3. In an example, a decrease in the grade of the helmet is not fixed. In one attack, if damage is greater, the decrease will be larger. In some embodiments, the above armor grade does not decrease with the number of times of use, but the number of times of use of the armor is limited. In an example, a Grade-4 helmet can be used for four times if there is no attack, and the helmet will lose its protection ability after it has been attacked for four times. That is, due to the method for adjusting the reference attribute value by multiplying the second adjustment coefficient, which is determined using the product result between the armor grade and the adjustment coefficient, by the reference attribute value, an adjustment effect will be different if the armor grade is different.

3. In a case that the influence factor includes the projection relationship factor, a projection area of the second virtual object within the functional range is obtained. A proportionality coefficient of the projection area of the second virtual object within the functional range to a reference projection area of the second virtual object is taken as a third adjustment coefficient, where the proportionality coefficient is greater than 0 and less than 1. The third adjustment coefficient is used for adjusting the reference attribute value using a product result obtained after multiplication with the reference attribute value. In some embodiments, when the specified function of the virtual prop is triggered, a current posture of the second virtual object is different. For example, implementation of the virtual prop as a virtual grenade prop is taken as an example for explanation. When the virtual grenade prop is triggered to be exploded, damage is caused to a virtual character by a fragment flying from an explosion point of the virtual grenade prop. When the virtual character is in different postures, the virtual character can be exposed to fragments in different quantities. The third adjustment coefficient is determined by obtaining the projection area of the virtual character within the explosion range. In an example, to obtain the third adjustment coefficient, it is necessary to obtain the projection area of the second virtual object within the functional range and the reference projection area of the second virtual object. The process of obtaining the above two projection areas will be described below:

First: Obtain the Projection Area of the Second Virtual Object within the Functional Range.

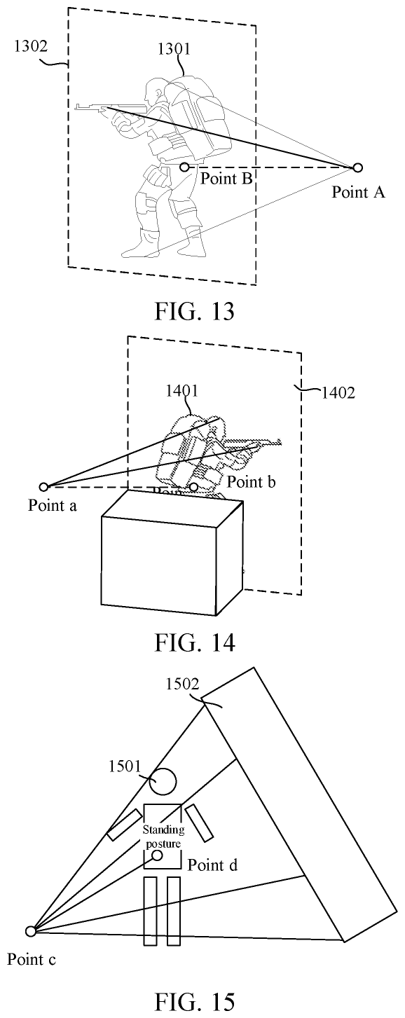

In some embodiments, the method for obtaining the projection area of the second virtual object within the functional range includes: creating a center bone point connecting line from the position to which the virtual prop is thrown to the second virtual object, and determining a projection plane perpendicular to the center bone point connecting line; and determining that a projection area of the second object part among the plurality of object parts on the projection plane is the projection area of the second virtual object within the functional range. In an example, a center bone point of the above second virtual object may be implemented as a middle position bone point of the second virtual object. In an example, the projection area of the second object part of the second virtual object on the projection plane is calculated, thereby obtaining the projection area of the second virtual object within the functional range. For example, if no obstacle exists between each of the respective object parts of the second virtual object and the virtual prop, as shown in FIG. 13, the explosion point of the virtual grenade prop is point A, and the center bone point of a virtual character 1301 is point B. A and B are connected, and a plane 1302 perpendicular to line segment AB is created, so that the plane 1302 is the projection plane. Connecting lines from point A to the bone points of the respective body parts of the virtual character 1301 are respectively created (it is worth noting that the connecting lines from point A to the bone points of the respective body parts of the virtual character 1301 need to be created as many as possible, and FIG. 13 only shows some of the connecting lines), and the above bone point connecting lines of the respective body parts are respectively extended to the plane 1302, so that a formed closed image is a projection of the virtual character 1301. An area of the closed image on the plane 1302 is calculated as the projection area of the virtual character within the explosion range, which is also the projection area of the second virtual object within the functional range. For example, if there is no obstacle existing between some of the object parts of the second virtual object and the virtual prop and there are obstacles existing between some other object parts and the virtual prop, as shown in FIG. 14, the explosion point of the virtual grenade prop is point a, and a center bone point of a virtual character 1401 is point b. Meanwhile, a and b are connected, and a plane 1402 perpendicular to line segment ab is created, so that the plane 1402 is the projection plane. The connecting lines between bone points on body parts of the lower half of the body of the virtual character 1401 and point a are blocked. If the connecting line between bone points on body parts of the upper half of the body of the virtual character 1401 and point a are not blocked, the connecting lines between the bone points on the body parts of the upper half of the body and a are respectively extended to the plane 1402, and an area of a closed image on the plane 1402 is calculated as the projection area of the virtual character within the explosion range, which is also the projection area of the second virtual object within the functional range. That is, the projection plane is determined according to the throwing position of the virtual prop and the center bone point connecting line of the second virtual object, thereby determining the projection area of the object parts on the projection plane as the projection area within the functional range, which can improve the accuracy of obtaining a projection area.

Second: Obtain the Reference Projection Area of the Second Virtual Object.

In some embodiments, the reference projection area of the second virtual object is obtained in at least one of the following ways: Way I: The reference projection area is a preset area, which is a front surface area of the second virtual object in the virtual scene. For example, the reference projection area of the virtual character is an area of a virtual character enclosed by an external contour in a standard standing posture. The reference projection area of a virtual vehicle is an area of a body of the vehicle exposed to the outside. Way II: The reference projection area is a projection area of the second virtual object on a target projection plane. For example, referring to FIG. 15, a virtual character stands in a virtual scene. The explosion point of the virtual grenade prop is point c, and the center bone point of the virtual character 1501 is point d. Meanwhile, c and d are connected, and a plane 1502 perpendicular to line segment cd is created, so that the plane 1502 is the projection plane. Point c and the bone points of the respective body parts are respectively connected, and the above respective line segments are respectively extended to the plane 1502. An area of a closed image on the plane 1502 is calculated as the reference projection area of the virtual character, which is also the reference projection area of the second virtual object. After the projection area of the second virtual object within the functional range and the reference projection area of the second virtual object are obtained, the third adjustment coefficient can be determined. For example, the proportionality coefficient of the projection area of the second virtual object within the functional range to the reference projection area of the second virtual object is calculated as the third adjustment coefficient, where the proportionality coefficient is greater than 0 and less than 1. A specific formula is as follows: Formula VI: X3=M/N, where X3 represents the third adjustment coefficient, X3∈(0,1); M represents the projection area of the second virtual object within the functional range; and N represents the reference projection area of the second virtual object. That is, when the second virtual object is in different postures within the functional range, the corresponding projection areas within the functional range are also different, so that the reference attribute value can be adjusted to be different according to the different postures of the second virtual object.

4. In a case that the influence factor includes the posture factor of the second virtual object, a current posture of the second virtual object is obtained. A posture coefficient corresponding to the posture is taken as a fourth adjustment coefficient, where the posture coefficient is greater than 0 and less than 1, and the fourth adjustment coefficient is used for adjusting the reference attribute value using a product result obtained after multiplication with the reference attribute value. In some embodiments, when the specified function of the virtual prop is triggered, the current posture of the second virtual object is different. Different postures correspond to different posture coefficients. For example, when the virtual prop is implemented as a virtual grenade prop, a relationship of the posture coefficients corresponding to different postures is as follows: standing posture>squatting posture>posture of lying prone. If the posture coefficient corresponding to the posture of the second virtual object when the specified function of the virtual prop is triggered, the fourth adjustment coefficient may be determined, where the posture coefficient is greater than 0 and less than 1. A specific formula is as follows: Formula VII: X4=Z, where X4 represents the fourth adjustment coefficient, X4∈(0,1); and Z represents the posture coefficient of the second virtual object. Through the above step, the fourth adjustment coefficient is calculated. The reference attribute value may be adjusted by multiplying the fourth adjustment coefficient by the reference attribute value. That is, the adjustment effect of the reference attribute value varies according to different postures of the virtual object.

5. In a case that the influence factor includes the resistance factor, a resistance coefficient of an environment in which the second object part of the second virtual object is located is obtained, where the resistance coefficient is greater than 0 and less than 1, and the resistance coefficient is used for adjusting the reference attribute value through multiplication with the reference attribute value. In some embodiments, if the virtual scene includes virtual water flow, the resistance coefficient when the virtual prop triggers the specified function includes a resistance coefficient in the virtual water flow. For example, when the explosion point of the virtual grenade prop is in the virtual water flow and can cause damage to a virtual character, a resistance of the water flow to the virtual grenade prop also needs to be calculated, because a resistance of an explosion fragment of the virtual grenade in the air is different from that in the water. The resistance corresponds to a resistance coefficient. A higher resistance corresponds to a smaller resistance coefficient. That is, the reference attribute value can be adjusted by obtaining the resistance coefficient when the virtual prop triggers the specified function and multiplying the resistance coefficient by the reference attribute value, which can improve the adjustment accuracy.

6. In a case that the influence factor includes the duration factor, a duration of triggering of the specified function by the virtual prop is obtained, and a duration influence coefficient is determined on the basis of the duration, where the duration influence coefficient is greater than 0 and less than 1, and the duration influence coefficient is used for adjusting the reference attribute value by multiplication with the reference attribute value. In some embodiments, the specified function triggered by the virtual prop corresponds to functional time, within which, the virtual prop can continuously exert an attribute value influence on a virtual object within the functional range. However, the above attribute value influence will gradually decrease or increase over time. That is, the reference attribute value can be adjusted by obtaining the duration influence coefficient when the virtual prop triggers the specified function and multiplying the duration influence coefficient by the reference attribute value, which improves the adjustment accuracy.

7. In some embodiments, the influence factor further includes a remaining attribute value factor. In a case that the influence factor includes the remaining attribute value factor of the second object part, a product between a level number corresponding to a remaining attribute value of the second object part and the adjustment coefficient is obtained as a fifth adjustment coefficient, where the adjustment coefficient is greater than 0 and less than 1, and the fifth adjustment coefficient is used for adjusting the reference attribute value through multiplication with the reference attribute value. In some embodiments, implementation of the virtual prop as a virtual first-aid prop is taken as an example for explanation. A smaller remaining attribute value means that a larger attribute value can be regained, so that a restoration effect of the virtual first-aid prop is better. Implementation of the attribute value as health points is taken as an example for explanation. If there are 100 health points in a full blood state, when the health points belong to (0, 30], it is at level 1, and the level number is 1, which means the best restoration effect; when the health points belong to (30, 60], it is at level 2, and the level number is 2; when the health points belong to (60, 90], it is at level 3, and the level number is 3; and when the health points belong to (90, 100], it is at level 4, and the level number is 4, which means the worst restoration effect. If there are 100 health points in the full blood state, the health points will be restored to 100 at most. The remaining attribute value of the second object part when the virtual prop triggers the specified function is obtained, and the adjustment coefficient is obtained at the same time, so that the fifth adjustment coefficient may be determined, where the adjustment coefficient is greater than 0 and less than 1. A specific formula is as follows: Formula VIII: X5=H*Z, where X5 represents the fifth adjustment coefficient; Z represents the adjustment coefficient, Z∈(0,1); and H represents the level number of the remaining attribute value of the second object part. Through the above step, the fifth adjustment coefficient is calculated. The reference attribute value may be adjusted by multiplying the fifth adjustment coefficient by the reference attribute value. That is, when existence situations of obstacles between the object parts and the virtual prop are different, the sub-attribute influence results generated by the object parts are different. Moreover, in a case that the object parts are in through connection to the virtual prop, the sub-attribute influence results can also be different according to different influence factors between the object parts and the virtual prop, which can improve the authenticity of the specified function of the virtual prop on the virtual object.

S3: Obtain the sub-attribute influence result corresponding to the second object part by adjusting the reference attribute value using the adjustment coefficient. In an example, the above one or more adjustment coefficients to adjust the reference attribute value to obtain the sub-attribute influence result corresponding to the second object part. If the first adjustment coefficient, the second adjustment coefficient, and the fourth adjustment coefficient are selected to adjust the reference attribute value, a calculation formula is as follows: Formula IX: S′=S*X1*X2*X4, where S represents the reference attribute value, and S′ represents an adjusted reference attribute value. In an example, if the second object part includes two or more object parts, the reference attribute value of each object part is adjusted to obtain a plurality of adjusted reference attribute values. That is, by setting the reference attribute value of an object part generated by the virtual prop in the ideal state, the adjustment coefficient is determined on the basis of the influence factor between the object part and the virtual prop. Finally, the sub-attribute influence result of the object part is obtained after the reference attribute value is adjusted according to the adjustment coefficient, so that different object parts have different adjustment ranges under different reference attribute values, which improve the fitness of changes in attribute influence results to object parts.

Step 1104: Obtain an attribute influence result of the second virtual object by fusing the sub-attribute influence results respectively corresponding to the plurality of object parts.

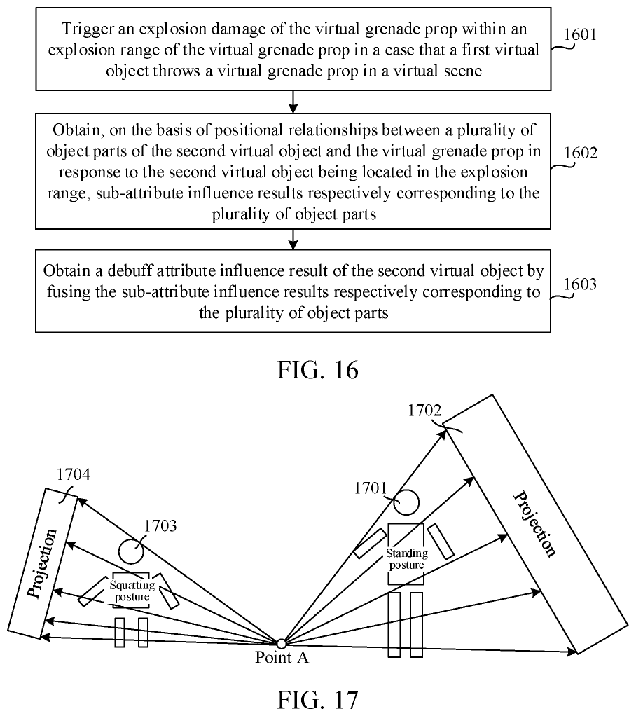

In some embodiments, in a case that the virtual prop is a virtual attack prop, the specified function of the virtual prop generates a debuff attribute influence result on the second virtual object. Implementation of the virtual attack prop as a virtual grenade prop is taken as an example for explanation. FIG. 16 is a flowchart of a virtual object display method according to an embodiment of this disclosure. The method may be applied to the terminals as shown in FIG. 2, or may be applied to the server as shown in FIG. 2. Application of the method to the server as shown in FIG. 2 is taken as an example for explanation. The method includes:

Step 1601: Trigger an explosion damage of the virtual grenade prop within an explosion range of the virtual grenade prop in a case that a first virtual object throws a virtual grenade prop in a virtual scene.

The explosion damage is used for generating a debuff effect on an attribute value of a virtual object within the explosion range. In some embodiments, the above virtual scene is implemented as a game battle picture between a second virtual object and the first virtual object, and the virtual grenade prop is a prop thrown by the first virtual object towards the second virtual object. A relationship between the first virtual object and the second virtual object may be an adversarial or cooperative relationship. In an example, when the first virtual object and the second virtual object are in the cooperative relationship, the virtual grenade prop correspondingly has an injury-free effect. For example, when a teammate of the second virtual object throws the virtual grenade prop in the virtual scene and the second virtual object is within the explosion range of the virtual grenade prop, the second virtual object may not be injured. In some embodiments, the above virtual scene may also be implemented as a throwing practice scene for the second virtual object. For example, in a shooting game, the second virtual object can practice throwing the virtual grenade prop in the throwing practice scene. The second virtual object can also experience the explosion damage of the virtual grenade prop in the throwing practice scene. In an example, the virtual grenade props thrown by the second virtual object may cause damage to the second virtual object. The attribute value includes the health points, line of sight range, hearing, and the like of a virtual object. When the virtual grenade prop is exploded at the vicinity of a virtual object, the health points of the virtual object may be decreased. The line of sight range of the virtual object is narrowed by scattered smoke, dust, fragments, and the like. Meanwhile, an explosion sound generated by the virtual grenade prop can reduce the hearing of the virtual object, so that the virtual object is unable to hear gunfire and footsteps of the first virtual object nearby. In some embodiments, the virtual grenade prop is an instantaneous damage prop. For example, the virtual grenade prop causes damage to a virtual object within the explosion range at the moment of explosion. After the explosion, the virtual grenade prop cannot cause damage. In some embodiments, the virtual grenade prop is a sustained damage prop, and the virtual grenade prop corresponds to a damage duration. In an example, the damage intensity and explosion range of the virtual grenade prop will gradually decrease during the damage duration. In an example, the damage duration of the virtual grenade prop is 3 seconds. At the 0^{th} second, the virtual grenade prop triggers the explosion damage. Within the 0^{th} second to the 1^{st} second, a damage level of the virtual grenade prop is level 3 (which is the highest damage level of the virtual grenade prop), and the explosion range is a circle range with a diameter of 24 meters. Within the 1^{st} second to the 2^{nd} second, a damage level of the virtual grenade prop is level 2, and the explosion range is a circle range with a diameter of 12 meters. Within the 2^{nd} second to the 3rd second, a damage level of the virtual grenade prop is level 1, and the explosion range is a circle range with a diameter of 6 meters. After 3 seconds, the explosion damage of the virtual grenade prop will fail.

Step 1602: Obtain, on the basis of positional relationships between a plurality of object parts of the second virtual object and the virtual grenade prop in response to the second virtual object being located in the explosion range, sub-attribute influence results respectively corresponding to the plurality of object parts.

The sub-attribute influence results are debuff results respectively generated by the plurality of object parts under the explosion damage.

In an example, whether the second virtual object is located in the explosion range is first determined. If the second virtual object is located in the explosion range, it indicates that the virtual grenade prop will cause damage to a mainly controlled virtual prop, and the sub-attribute influence results respectively corresponding to the plurality of object parts are obtained. In some embodiments, connecting lines from an explosion center to bone points of the plurality of object parts are created. If at least one bone point connecting line is within the explosion range, it indicates that the second virtual object is located in the explosion range. If all the bone point connecting lines exceed the explosion range, it indicates that the second virtual object is not located in the explosion range. In some embodiments, positional relationships between the plurality of object parts and the virtual grenade prop are determined by respectively creating the connecting lines between the explosion center and the bone points of the plurality of object parts, thereby obtaining the sub-attribute influence results respectively corresponding to the plurality of object parts. In an example, a position to which the virtual grenade prop is thrown in the virtual scene is the explosion center of the virtual grenade prop, and connecting lines from the explosion center to the bone points of the plurality of object parts are respectively created. The plurality of object parts may be classified according to the bone point connecting lines: If the connecting line between the explosion center and an object part is blocked, it indicates that the object part belongs to the first object part, and the virtual grenade prop will not cause damage to the first object part, that is, the attribute value of the first object part will not decrease. If the connecting line between the explosion center and an object part is not blocked, it indicates that the object part belongs to the second object part, and the virtual grenade prop may cause damage to the second object part. Through an influence factor between the second object part and the virtual grenade prop, whether damage will be caused to the second object part and the sub-attribute influence result corresponding to the second object part need to be determined. First, whether the virtual grenade prop will cause damage to the second object part is determined on the basis of a distance factor. In an example, whether the connecting line between the bone point of the second object part and the explosion center exceeds a distance threshold is determined. If the connecting line exceeds the distance threshold, it indicates that the virtual grenade prop will not cause damage to the second object part, which means that the attribute value of the second object part will not decrease. Second, if the connecting line between the bone point of the second object part and the explosion center does not exceed the distance threshold, it indicates that the virtual grenade prop will cause damage to the second object part.

In an example, if the second object part that does not exceed the distance threshold includes the left leg and the head:

1: Obtain initially set reference damage values of the virtual grenade prop for the left leg and the head, for example: the reference damage value for the left leg being 20, and the reference damage value for the head being 50.

2: Obtain a first adjustment coefficient corresponding to the distance factor, for example: a distance to the left leg being 4 meters, a distance to the head being 5 meters, a preset adjustment base number being 0.9, and reference damage values adjusted on the basis of the first adjustment coefficient being as follows: Left leg=40*0.9\hat{ }4=13.122; Head=50*0.9\hat{ }5=29.525.

3: Obtain a second adjustment coefficient corresponding to an armor factor. Before the obtaining of the second adjustment coefficient, first determine whether the left leg and head of the second virtual object are equipped with armor props. For example: if the left leg is equipped with a Grade-2 armor prop and the head is not equipped with an armor prop, and if a specified adjustment coefficient is 0.1, reference damage values adjusted on the basis of the first adjustment coefficient and the second adjustment coefficient are as follows: Left leg=13.122*0.8=10.4976; and Head=29.525 (the head does not need to be adjusted because there is no armor prop).

4: Obtain a third adjustment coefficient corresponding to a projection relationship factor by obtaining a reference projection area and a projection area of the second virtual object within the explosion range. A method for obtaining the reference projection area and the projection area of the second virtual object within the explosion range has been explained in detail in step 1103 and will not be repeated here. For example: the reference projection area is 10; the projection area of the second virtual object within the explosion range is 5; and it can be seen that the third adjustment coefficient is 0.5. Therefore, reference damage values adjusted on the basis of the first adjustment coefficient, the second adjustment coefficient, and the third adjustment coefficient are as follows: Left leg=10.4976*0.5=5.2488; and Head=29.525*0.5=14.7625.

In some embodiments, a posture of the second virtual object that is about to be damaged by the explosion can also be directly detected, and the damage can be reduced on the basis of the posture. For example, when the same virtual grenade prop is exploded, damage to the second virtual object in a squatting posture is less than damage to the second virtual object in a standing posture. Referring to FIG. 17, a virtual object 1701 is in a standing posture, while a virtual object 1703 is in a squatting posture. The virtual object 1701 and the virtual object 1703 belong to the same virtual object, and distances from them to point A of an explosion center are the same. As shown in FIG. 17, an area of a projection 1702 of the virtual object 1701 is significantly larger than an area of a projection 1704 of the virtual object 1703, indicating that it is clear that the virtual object 1701 has a larger exposure area in face of the explosion center, which means that the virtual object suffers greater damage. The above third adjustment coefficient can also be implemented as a posture coefficient corresponding to the posture of the second virtual object when the virtual grenade prop is exploded. For example, the posture of the second virtual object when the virtual grenade explosion is exploded is squatting, and the posture coefficient is 0.5, so that reference damage values adjusted on the basis of the first adjustment coefficient, the second adjustment coefficient, and the third adjustment coefficient are as follows: Left leg=10.4976*0.5=5.2488; and Head=29.525*0.5=14.7625.

Step 1603: Obtain a debuff attribute influence result of the second virtual object by fusing the sub-attribute influence results respectively corresponding to the plurality of object parts.

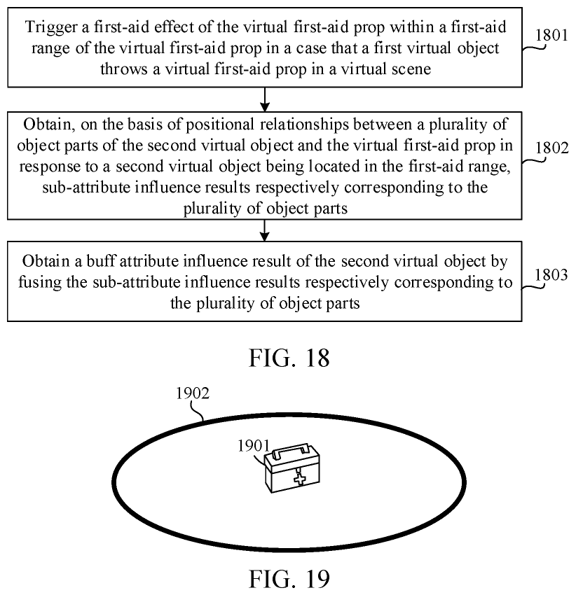

In an example, the sub-attribute influence result of the above virtual grenade prop on the second virtual object indicates a decrease of 5.2488 to the health points of the left leg, and a decrease of 14.7625 to the health points of the head. The damage value of the left leg and the damage value of the head are added together to obtain the attribute influence result of the second virtual object, which means a total decrease of 20.0113 to the health points of the virtual object. That is, different kinds of virtual props generate different attribute influence results, which can improve the diversity of props that influence attributes. In some embodiments, in a case that the virtual prop is a virtual medical prop, the specified function of the virtual prop generates a buff attribute influence result on the second virtual object. Implementation of the virtual medical prop as a virtual first-aid prop is taken as an example for explanation. FIG. 18 is a flowchart of a virtual object display method according to an embodiment of this disclosure. The method may be applied to the terminals as shown in FIG. 2, or may be applied to the server as shown in FIG. 2. Application of the method to the server as shown in FIG. 2 is taken as an example for explanation. The method includes:

Step 1801: Trigger a first-aid effect of the virtual first-aid prop within a first-aid range of the virtual first-aid prop in a case that a first virtual object throws a virtual first-aid prop in a virtual scene.

The first-aid effect is used for generating a buff effect on an attribute value of a virtual object within the first-aid range. In an example, the recovery ability and first-aid range of the virtual first-aid prop will slowly decrease during a recovery duration. In an example, the recovery duration of the virtual first-aid prop is 3 seconds. At the 0^{th} second, the virtual first-aid prop triggers the first-aid effect. Within the 0^{th} second to the 1^{st} second, a recovery level of the virtual first-aid prop is level 3 (which is the highest recovery level of the virtual first-aid prop), and the first-aid range is a circle range with a diameter of 24 meters. Within the 1^{st} second to the 2^{nd} second, a recovery level of the virtual first-aid prop is level 2, and the first-aid range is a circle range with a diameter of 12 meters. Within the 2^{nd} second to the 3rd second, a recovery level of the virtual first-aid prop is level 1, and the first-aid range is a circle range with a diameter of 6 meters. After 3 seconds, the first-aid effect of the virtual first-aid prop will fail. In some embodiments, a first-aid effect identifier of the virtual first-aid prop and a first-aid range identifier of the virtual first-aid prop may also be triggered to be displayed within the first-aid range. In an example, the virtual first-aid prop corresponds to a first-aid duration. After the virtual first-aid prop triggers the first-aid effect, if the second virtual object is not within the first-aid range, the second virtual object cannot be treated. However, the first-aid effect of the virtual first-aid prop may last for a period of time. If the second virtual object moves into the first-aid range during this period of time, the second virtual object can be treated. Referring to FIG. 19, if the first-aid effect identifier of the virtual first-aid prop and the first-aid range identifier of the virtual first-aid prop are triggered to be displayed, the first-aid effect identifier 1901 is displayed in the virtual scene. The second virtual object can quickly locate and find, according to the first-aid effect identifier, the virtual first-aid prop that has been triggered and know the type of the virtual first-aid prop. The first-aid range identifier 1902 is highlighted, and the second virtual object can know a current first-aid range of the virtual first-aid prop.

Step 1802: Obtain, on the basis of positional relationships between a plurality of object parts of the second virtual object and the virtual first-aid prop in response to a second virtual object being located in the first-aid range, sub-attribute influence results respectively corresponding to the plurality of object parts.

The sub-attribute influence results are buff results respectively generated by the plurality of object parts under the first-aid effect. For example, whether the second virtual object is located in the first-aid range is first determined. If the second virtual object is located in the first-aid range, it indicates that the virtual first-aid prop will perform first aid on the second virtual object, and the sub-attribute influence results respectively corresponding to the plurality of object parts are obtained. In some embodiments, connecting lines from a trigger position of the virtual first-aid prop to bone points of the plurality of object parts are created. If at least one bone point connecting line is within the first-aid range, it indicates that the second virtual object is located in the first-aid range. If all the bone point connecting lines exceed the first-aid range, it indicates that the second virtual object is not located in the first-aid range. In some embodiments, positional relationships between the plurality of object parts and the virtual first-aid prop are determined by respectively creating the connecting lines between the trigger position of the virtual first-aid prop and the bone points of the plurality of object parts, thereby obtaining the sub-attribute influence results respectively corresponding to the plurality of object parts.

In an example, the plurality of object parts may be classified according to the bone point connecting lines: If the connecting line between the trigger position of the virtual first-aid prop and an object part is blocked, it indicates that the object part belongs to a first object part, and the virtual first-aid prop will not have an effect on the first object part, that is, the attribute value of the first object part will not increase. If the connecting line between the trigger position of the virtual first-aid prop and an object part is not blocked, it indicates that the object part belongs to the second object part, and the virtual first-aid prop may have an effect on the second object part. Through an influence factor between the second object part and the virtual first-aid prop, whether an effect will be achieved on the second object part and the sub-attribute influence result corresponding to the second object part need to be determined.

First, whether the virtual first-aid prop will have an effect on the second object part is determined on the basis of a distance factor. In an example, whether the connecting line between the bone point of the second object part and the trigger position of the virtual first-aid prop exceeds a distance threshold is determined. If the connecting line exceeds the distance threshold, it indicates that the virtual first-aid prop will not have an effect on the second object part, which means that the attribute value of the second object part will not increase.

Second, if the connecting line between the bone point of the second object part and the trigger position of the virtual first-aid prop does not exceed the distance threshold, it indicates that the virtual first-aid prop will have an effect on the second object part. In some embodiments, the sub-attribute influence result corresponding to the first virtual object part is determined through at least one of the distance factor and a remaining attribute value factor of the second object part.

In an example, if the second object part that does not exceed the distance threshold includes the left leg and the head:

1: Obtain initially set reference recovery values of the virtual first-aid prop for the left leg and the head, for example: the reference recovery value for the left leg being 20, and the reference recovery value for the head being 50.

2: Obtain a first adjustment coefficient corresponding to the distance factor, for example: a distance to the left leg being 4 meters, a distance to the head being 5 meters, a preset base number being 0.9, and reference recovery values adjusted on the basis of the first adjustment coefficient being as follows: Left leg=40*0.9\hat{ }4=13.122; Head=50*0.9\hat{ }5=29.525.

3: Obtain a second adjustment coefficient corresponding to the remaining attribute value factor of the second object part. For example: if the left leg has 38 remaining health points, a corresponding level number is 2; if the head has 85 remaining health points, a corresponding level number is 3. In addition, a specified coefficient is 0.1. Therefore, reference recovery values adjusted on the basis of the first adjustment coefficient and the second adjustment coefficient are as follows: Left leg=13.122*0.2=2.6244; and Head=29.525*0.1=2.9525.

In an example, the above recovery values adjusted on the basis of the first adjustment coefficient and the second adjustment coefficient are reference recovery reduction values. Therefore, a recovery value of the second object part is obtained by subtracting a reference recovery value by a reference recovery reduction value. Final recovery values of the object part are as follows: Left leg=20-2.6244=17.3756; and Head=50-2.9525=47.0475. That is, the sub-attribute influence result is obtained.

Step 1803: Obtain a buff attribute influence result of the second virtual object by fusing the sub-attribute influence results respectively corresponding to the plurality of object parts.

In some embodiments, the sub-attribute influence results respectively corresponding to the plurality of object parts are added together to obtain the buff attribute influence result of the second virtual object.

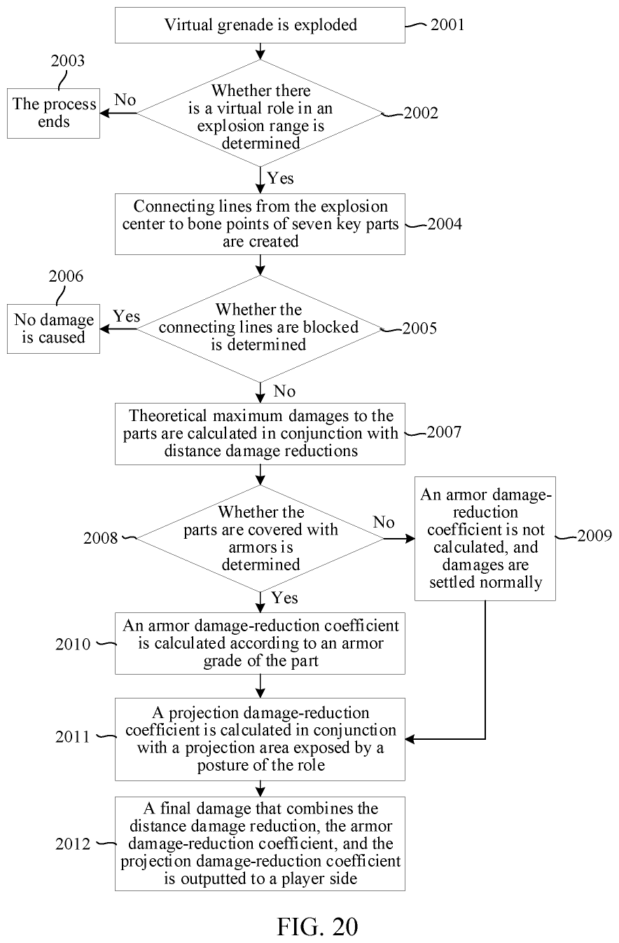

In some embodiments, the above virtual prop is implemented as a virtual grenade. FIG. 20 is a flowchart of a virtual object display method according to one exemplary embodiment of this disclosure. As shown in FIG. 20, the method includes:

Step 2001: A virtual grenade is exploded.

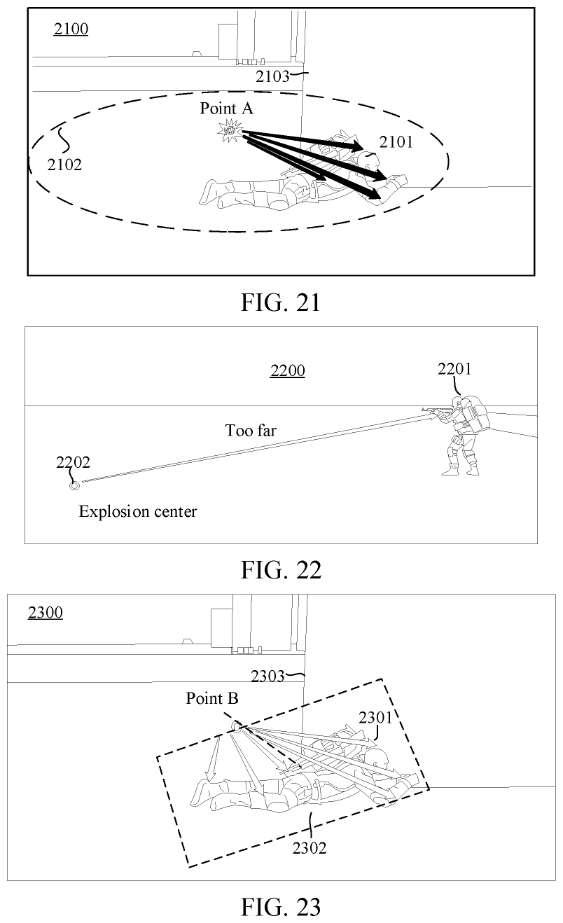

Referring to FIG. 21, an animation of the virtual grenade being exploded is displayed in a virtual scene 2100, where an explosion center of the explosion of the virtual grenade is point A.

The virtual scene further includes a virtual role 2101. The virtual role 2101 is in a posture of lying prone in the virtual scene 2100 and transversely faces the explosion center point A.

In an example, the virtual grenade is thrown by the virtual role 2101 in the virtual scene 2100. Or, the virtual grenade is thrown into the virtual scene 2100 by a virtual role controlled by another player or a non-player role.

Step 2002: Whether there is a virtual role in an explosion range is determined.

That is, whether the virtual role exists in the explosion range of the virtual grenade is detected.

In an example, the explosion range of the virtual grenade includes at least one of the following ranges:

1. A circle range taking the explosion center of the virtual grenade as a circle center and taking a preset distance as a radius is the explosion range of the virtual grenade.

2. A sector range taking the explosion center of the virtual grenade as a circle center, taking a preset angle as a central angle, and taking a preset distance as a radius is the explosion range of the virtual grenade.

Step 2003: If there is no virtual role in the explosion center, the process ends.

In an example, referring to FIG. 22, in a virtual scene 2200, when the virtual grenade is exploded and a virtual role 2201 in the figure is too far away from an explosion center 2202, calculation of damage of the virtual grenade to the virtual role 2201 ends, that is, the process ends.

Step 2004: If there is a virtual role in the explosion center, connecting lines from the explosion center to bone points of seven key parts are created.

For example, referring to FIG. 21, a region 2102 represents the explosion range of the virtual grenade. The region 2102 is a circle taking the explosion center as a circle center and having a radius of 12 meters. If the virtual role 2101 is in the region 2102, it indicates that the virtual role will suffer an explosion damage of the virtual grenade.

In response to the virtual role existing within the explosion range of the virtual grenade, the connecting lines from the explosion center to the bone points of the seven key parts of the virtual role are created. As shown in FIG. 21, the explosion center is point A. A left arm bone point connecting line, a right arm bone point connecting line, a head bone point connecting line, a chest bone point connecting line, an abdomen bone point connecting line, a left leg bone point connecting line, and a right leg bone point connecting line of the virtual role 2101 are respectively created from point A.

Step 2005: Whether the connecting lines are blocked is determined.

That is, whether the connecting lines between the explosion center and the bone points of the seven key parts are blocked are respectively determined.

In an example, whether the connecting lines created from the explosion center point A to the bone points of the respective body parts of the virtual role 2101 are blocked by obstacles is determined.

Step 2006: If the connecting lines are blocked, no damage is caused.

If the connecting line between the explosion center and the bone point of the head is blocked, it means that the explosion will not cause damage to the head of the virtual role.

As shown in FIG. 21, the upper part of the body of the virtual role 2101 is behind an enclosing wall 2103. The black connecting lines in the figure represent connecting lines that are blocked by the enclosing wall 2103, indicating that the left arm, the right arm, the head, and the chest may not suffer the explosion damage.

Step 2007: If the connecting lines are not blocked, theoretical maximum damages to the parts are calculated in conjunction with distance damage reductions.

For example, as shown in FIG. 21, the white connecting lines represent connecting lines that are not blocked by the enclosing wall 2103. Therefore, the left leg, right leg, and abdomen of the virtual role will suffer the explosion damage. The theoretical maximum damages of the virtual grenade to the left leg, right leg, and abdomen of the virtual role are calculated separately below, where the theoretical maximum damages are determined by initial explosion damage values and the distance damage reductions. Firstly, initial damage values of the virtual grenade on the respective body parts of the virtual role are determined. In an example, rates of the damage of the virtual grenade to different body parts of the virtual role are different, and a proportion of damage to each part may be set. For example: to emphasize “Protect the head”, the proportion of the explosion damage to the head is increased, and vice versa. The initial explosion damage values of the virtual grenade may be configured: at an extremely short distance, the explosion damage of the virtual grenade causes a decrease of 60 health points to the head, causes a decrease of 40 health points to the left/right arm, causes a decrease of 50 health points to the chest/abdomen, and causes a decrease of 40 health points to the left leg/right leg. Secondly, the distance damage reductions of the virtual grenade on the respective body parts of the virtual role are determined. In an example, a formula of the distance damage reduction is as follows: Formula X: F(X)=0.9\hat{ }X∈(0,12], F(X)=0, X∈(12, +∞). That is, within 12 meters, the damage is reduced at a rate of 0.9\hat{ }X (X is a distance), and beyond 12 meters, the damage is 0.

According to the above explanation, for example, the distances between the respective body parts of the virtual role and the explosion center are calculated separately. In FIG. 21, according to positions of the two legs and a position of the abdomen from the explosion center, the left leg is closest to the explosion center and is 4 meters away, which is followed by the abdomen 5 meters away, and the right leg is farthest from the explosion center and is 6 meters away. Damages reduced on the basis of the distances to the respective parts are calculated as follows: Left leg=40*0.9\hat{ }4=26.244; Abdomen=50*0.9\hat{ }5=29.525; and Right leg=40*0.9\hat{ }6=21.25764. These are the theoretical maximum damages to the respective parts.

Step 2008: Whether the parts are covered with armors is determined.

That is, whether the body parts of the virtual role are covered by armors is determined.

In an example, whether the head, chest, abdomen, hands, and legs of the virtual role are covered with the armors is checked in sequence. Only the parts covered with the armors will be less damaged.

Step 2009: If a part is not covered with an armor, an armor damage-reduction coefficient is not calculated, and damages are settled normally.

In an example, as shown in FIG. 21, the left leg and right leg of the virtual role 2101 are not covered with armors, so there is no armor for damage reduction, and there is no need to calculate the armor damage-reduction coefficient. The damages can be settled normally, that is, the damage to the left leg is 26.244, and the damage to the right leg is 21.25764. Step 2011 is executed.

Step 2010: If a part is covered with an armor, an armor damage-reduction coefficient is calculated according to an armor grade of the part.

In an example, armors correspond to armor grades, and armor damage-reduction coefficient corresponding to different armor grades are different. The armor damage-reduction coefficient is determined by an armor damage reduction rate, and a formula for the armor damage reduction rate is as follows: Formula XI: O=0.1*Y, where Y represents the armor grade, so that the armor damage-reduction coefficient is 1-O. As shown in FIG. 21, the abdomen of the virtual role 2101 is covered with a Grade-5 armor, and the armor damage-reduction coefficient of the Grade-5 armor is 1-0.1*5=0.5. Therefore, after the armor damage-reduction coefficient is calculated, the damage of the virtual grenade to the abdomen is 29.525*0.5=14.7625.

In some embodiments, after the armor achieves damage reduction, the durability of the armor may be decreased to a certain extent, and the damage reduction coefficient of the armor will increase as the durability of the armor decreases. That is, the damage reduction effect of the armor will be reduced as the durability of the armor decreases.

Step 2011: A projection damage-reduction coefficient is calculated in conjunction with a projection area exposed by a posture of the role.

The explosion damage of the virtual grenade may be calculated according to a projection of the virtual role exposed to the virtual grenade. If the exposed projection is smaller, the damage of the grenade to the virtual role is less.

In an example, a ratio of the projection area of the virtual role exposed to the explosion center to a reference projection area of the virtual role is the projection damage-reduction coefficient. I: Obtain the projection area of the virtual role exposed to the explosion center. Firstly, a projection plane needs to be determined. As shown in FIG. 23, in a virtual scene 2300, the explosion center of the virtual grenade is point B. A connecting line from point B to a center bone point of a virtual role 2301 is created, and a plane 2302 perpendicular to the connecting line is made, which is the projection plane. Secondly, connecting lines from the explosion center point B to bone points of the head, feet, and other body parts of the virtual role 2301 are created. Projections of extended lines of the connecting lines on the plane represent a first projection area corresponding to a current posture of the virtual role 2301. From FIG. 23, it can be seen that half of the body parts of the virtual role 2301 are covered by an enclosing wall 2303, so that it is finally obtained that a projection area exposed by the virtual role 2301 is a half of the first projection area. II: Obtain the reference projection area of the virtual role. In an example, in a standing posture of the virtual role, connecting lines from the explosion center point B to bone points of the head, feet, and other body parts of the virtual role are created. Projections of extended lines of the connecting lines on the plane represent the reference projection area of the virtual role. Referring to FIG. 23, it can be seen that the virtual role 2301 lies horizontally prone on the ground, facing the explosion center. Therefore, the projection area of the virtual role 2301 in the posture of lying prone and the projection area of the virtual role in the standing posture are less different, and the reference projection area of the virtual role 2301 is the first projection area. Therefore, the projection damage-reduction coefficient is about 0.5.

Step 2012: A final damage that combines the distance damage reduction, the armor damage-reduction coefficient, and the projection damage-reduction coefficient is outputted to a player side.

The virtual scenes in FIG. 21 and FIG. 23 are the same virtual scene, so the projection damage-reduction coefficient of the virtual role 2301 calculated in FIG. 23 is also the projection damage-reduction coefficient of the virtual role 2201 in FIG. 22.

The distance damage-reduction coefficients and the armor damage-reduction coefficients have been calculated in step 2007 to step 2010. Finally, with reference to the damage-reduction coefficients, the final damages to the respective parts of the virtual role 2101 can be obtained as follows: Left leg: 26.244*0.5=13.122; Right leg: 21.25764*0.5=13.122; and Abdomen: 14.7625*0.5=7.38125. A total damage to the virtual role 2101 is: 13.122+13.122+7.38125=33.62525. In an example, the total damage to the virtual role 2101 is displayed in the virtual scene 2101.

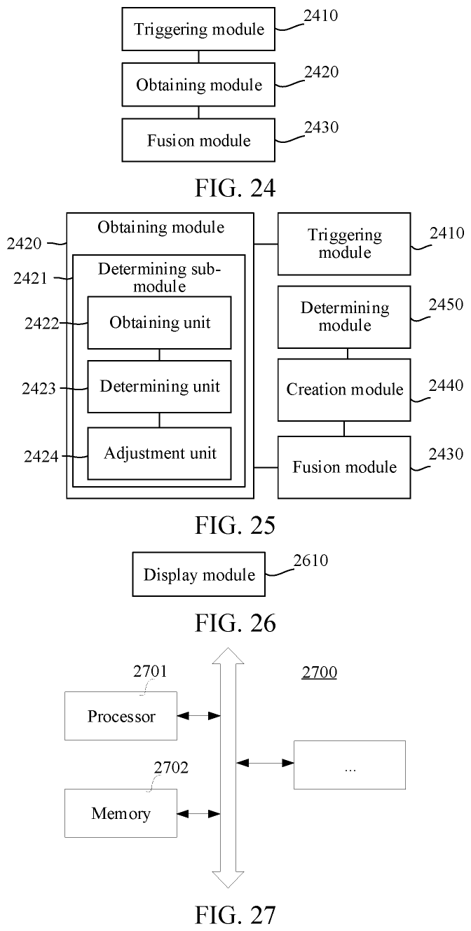

FIG. 24 shows a structural block diagram of a virtual object display apparatus provided according to one exemplary embodiment of this disclosure. The apparatus includes a triggering module 2410, an obtaining module 2420, and a fusion module 2430.

The triggering module 2410 is configured to: trigger a specified function of the virtual prop within a functional range of the virtual prop in a case that a first virtual object throws a virtual prop in a virtual scene, the specified function being used for exerting an influence on an attribute value of a virtual object located in the functional range.

The obtaining module 2420 is configured to: obtain, on the basis of positional relationships between a plurality of object parts of the second virtual object and the virtual prop in response to a second virtual object being located in the functional range, sub-attribute influence results respectively corresponding to the plurality of object parts, the sub-attribute influence results being influence results respectively generated by the plurality of object parts under the specified function.

The fusion module 2430 is configured to: obtain an attribute influence result of the second virtual object by fusing the sub-attribute influence results respectively corresponding to the plurality of object parts, the attribute influence result referring to an overall influence result generated by the specified function of the virtual prop on the second virtual object.

In some embodiments, the fusion module 2430 is further configured to: obtain the attribute influence result of the second virtual object by summating the sub-attribute influence results respectively corresponding to the plurality of object parts; or, configured to: obtain the attribute influence result of the second virtual object by performing weighted summation on the sub-attribute influence results respectively corresponding to the plurality of object parts.

Referring to FIG. 25, in some embodiments, the obtaining module 2420 includes: a determining sub-module 2421, configured to determine, in a case that an obstacle exists between a first object part among the plurality of object parts and the virtual prop, that the first object part avoids a sub-attribute influence exerted by the specified function; and the determining sub-module 2421 being further configured to determine, on the basis of an influence factor between the second object part and the virtual prop in a case that a second object part among the plurality of object parts achieves through connection between the virtual prop, the sub-attribute influence result corresponding to the second object part, where the influence factor includes at least one of a distance factor, an armor factor, a projection relationship factor, a posture factor of the second virtual object, a resistance factor, and a duration factor.

In some embodiments, the apparatus further includes: a creation module 2440, configured to create bone point connecting lines respectively corresponding to the plurality of object parts from a position to which the virtual prop is thrown; and a determining module 2450, configured to determine, in response to that the bone point connecting line corresponding to the first object part among the plurality of object parts is blocked, that an obstacle exists between the first object part and the virtual prop, the determining module 2450 being further configured to determine, in response to that the bone point connecting line corresponding to the second object part among the plurality of object parts achieves through connection between the second object part and the virtual prop, that no obstacle exists between the second object part and the virtual prop.

In some embodiments, the determining sub-module 2421 includes: an obtaining unit 2422, configured to obtain a reference attribute value corresponding to the second object part, the reference attribute value referring to an attribute influence result generated on the second object part in a case that no obstacle exists between the virtual prop and the second object part; a determining unit 2423, configured to determine, on the basis of the influence factor between the second object part and the virtual prop, an adjustment coefficient for adjusting the reference attribute value; and an adjustment unit 2424, configured to obtain the sub-attribute influence result corresponding to the second object part by adjusting the reference attribute value using the adjustment coefficient.

In some embodiments, the determining unit 2423 is configured to: take a distance between the second object part and the virtual prop as an exponential coefficient in a case that the influence factor includes the distance factor, and take a product result of an adjustment base number under the exponential coefficient as a first adjustment coefficient, the adjustment base number being greater than 0 and less than 1, the first adjustment coefficient being used for adjusting the reference attribute value using a product result obtained after multiplication with the reference attribute value; and the determining unit 2423 is further configured to determine, in a case that the influence factor includes the armor factor, a second adjustment coefficient on the basis of a product between an armor grade corresponding to the armor factor and the adjustment coefficient, the adjustment coefficient being greater than 0 or equal to 1, and the second adjustment coefficient being used for adjusting the reference attribute value using a product result obtained after multiplication with the reference attribute value.

In some embodiments, the determining unit 2423 is configured to: obtain a projection area of the second virtual object within the functional range in a case that the influence factor includes the projection relationship factor; and take a proportionality coefficient of the projection area of the second virtual object within the functional range to a reference projection area of the second virtual object as a third adjustment coefficient, the proportionality coefficient being greater than 0 and less than 1, and the third adjustment coefficient being used for adjusting the reference attribute value using a product result obtained after multiplication with the reference attribute value.

In some embodiments, the determining unit 2423 is configured to: create a center bone point connecting line from the position to which the virtual prop is thrown to the second virtual object, and determine a projection plane perpendicular to the center bone point connecting line; and the determining unit 2423 is further configured to determine that a projection area of the second object part among the plurality of object parts on the projection plane is the projection area of the second virtual object within the functional range.

In some embodiments, the determining unit 2423 is configured to: obtain a current posture of the second virtual object in a case that the influence factor includes the posture factor of the second virtual object; and take a posture coefficient corresponding to the posture as a fourth adjustment coefficient, the posture coefficient being greater than 0 and less than 1, and the fourth adjustment coefficient being used for adjusting the reference attribute value using a product result obtained after multiplication with the reference attribute value.

In some embodiments, the determining unit 2423 is configured to: obtain, in a case that the influence factor includes the resistance factor, a resistance coefficient of an environment in which the second object part of the second virtual object is located, the resistance coefficient being greater than 0 and less than 1, and the resistance coefficient being used for adjusting the reference attribute value through multiplication with the reference attribute value; and obtain, in a case that the influence factor includes the duration factor, a duration of triggering of the specified function of the virtual prop, and determine a duration influence coefficient on the basis of the duration, the duration influence coefficient being greater than 0 and less than 1, and the duration influence coefficient being used for adjusting the reference attribute value using a product result obtained after multiplication with the reference attribute value.

In some embodiments, the obtaining unit 2422 is further configured to: obtain an obstacle attribute of the obstacle in a case that an obstacle exists between the first object part and the virtual prop; the determining unit 2423 is further configured to determine an attribute influence of the specified function of the virtual prop on the obstacle attribute; and the determining unit 2423 is further configured to determine, in response to that the specified function meets a penetration requirement for the attribute influence of the obstacle attribute, the sub-attribute influence exerted by the obstacle on the first object part under the influence of the specified function.

In some embodiments, the obstacle includes a virtual wall for covering the first object part; the obstacle attribute of the virtual wall includes an upper limit of wall damage coverage. The determining unit 2423 is further configured to determine, in response to that an attack value of the specified function on the wall reaches the upper limit of wall damage coverage, the sub-attribute influence exerted by the wall on the first object part in a destroying and exploding process.

In some embodiments, in a case that the virtual prop is a virtual attack prop, the specified function of the virtual prop generates a debuff attribute influence result on the second virtual object; and in a case that the virtual prop is a virtual medical prop, the specified function of the virtual prop generates a buff attribute influence result on the second virtual object.

FIG. 26 shows a structural block diagram of a virtual object display apparatus provided according to another exemplary embodiment of this disclosure. The apparatus includes a display module 2610.

The display module 2610 is configured to: display a second virtual object, the second virtual object including a plurality of object parts, and the second virtual object being a virtual object mainly controlled by a current terminal.

The display module 2610 is further configured to: display a virtual prop thrown into a virtual scene, the virtual prop being used for triggering a specified function within a functional range after being thrown into the virtual scene, and the specified function being used for exerting an influence on an attribute value of a virtual object located in the functional range.

The display module 2610 is further configured to display the specified function of the virtual prop triggered within the functional range.

The display module 2610 is further configured to: display an attribute influence result of the second virtual object in response to the second virtual object being located in the functional range, the attribute influence result being a result obtained by integrating sub-attribute influence results respectively corresponding to the plurality of object parts, and the sub-attribute influence results being influence results respectively generated by the plurality of object parts under the specified function.

In some embodiments, the display module 2610 is further configured to: in response to the second virtual object being located in the functional range, display, in a case that an obstacle exists between a first object part of the second virtual object and the virtual prop, the sub-attribute influence result of the first object part avoiding the specified function; and the display module 2610 is further configured to display the sub-attribute influence result of the second object part under the influence of the specified function in a case that through connection is achieved between a second object part among the plurality of object parts and the virtual prop.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 27 is a structural block diagram of a computer device 2700 according to one exemplary embodiment of this disclosure. The computer device 2700 may be: a smartphone, a tablet computer, a Moving Picture Experts Group Audio Layer III (MP3) player, a Moving Picture Experts Group Audio Layer IV (MP4) player, a notebook computer, or a desktop computer. The computer device 2700 may also be referred to as another name such as user equipment, a portable computer device, a laptop computer device, and a desktop terminal. Generally, the computer device 2700 includes: a processor 2701 and a memory 2702. The processor 2701 may include one or more processing cores, for example, a 4-core processor or an 8-core processor. Processing circuitry, such as the processor 2701, may be implemented in at least one hardware form of a digital signal processor (DSP), a field-programmable gate array (FPGA), and a programmable logic array (PLA). The processor 2701 may also include a main processor and a coprocessor. The main processor is a processor configured to process data in an awake state, and is also referred to as a central processing unit (CPU). The coprocessor is a low power processor configured to process the data in a standby state. In some embodiments, the processor 2701 may be integrated with a graphics processing unit (GPU). The GPU is configured to render and draw content that needs to be displayed on a display screen. In some embodiments, the processor 2701 may further include an artificial intelligence (AI) processor. The AI processor is configured to process computing operations related to machine learning.

The memory 2702 may include one or more computer-readable storage media. The computer-readable storage medium may be non-transient or non-transitory. The memory 2702 may further include a high-speed random access memory and a nonvolatile memory, for example, one or more disk storage devices or flash storage devices. In some embodiments, the non-transient computer-readable storage medium in the memory 2702 is configured to store at least one instruction, and the at least one instruction is configured to be executed by the processor 2701 to perform the virtual object display method provided in the method embodiments in this disclosure.

the computer device 2700 further includes other components. A person skilled in the art can understand that the structures shown in FIG. 27 do not constitute a limitation on the computer device 2700 which may include more or fewer components than those shown in the figure. Further, some components may be combined, or a different component deployment may be used.

What is claimed is:

1. A method for processing a virtual effect in a virtual scene, the method comprising:
generating the virtual effect in the virtual scene, the virtual effect being configured to change an attribute value of a virtual object that is located within a functional range of the virtual effect;
determining, based on positional relationships between a plurality of body parts of the virtual object and the virtual effect in the virtual scene, a sub-attribute change value for each of the plurality of body parts of the virtual object that is affected by the virtual effect; and
determining, by processing circuitry, a change to the attribute value of the virtual object based on the sub-attribute change value of each of the plurality of body parts of the virtual object that is affected by the virtual effect.

2. The method according to claim 1, wherein the sub-attribute change value of a first body part of the plurality of body parts that is affected by the virtual effect is different from the sub-attribute change value of a second body part of the plurality of body parts that is affected by the virtual effect.

3. The method according to claim 1, wherein the plurality of body parts includes at least one appendage of the virtual object.

4. The method according to claim 1, wherein the virtual effect includes an explosion that is generated by a virtual prop thrown by another virtual object in the virtual scene.

5. The method according to claim 1, wherein the determining the change to the attribute value comprises:
determining the change to the attribute value based on a weighted sum of the sub-attribute value change of each of the plurality of body parts of the virtual object that is affected by the virtual effect.

6. The method according to claim 1, further comprising:
determining, when an obstacle exists between a first body part of the plurality of body parts and the virtual effect, that the first body part is not affected by the virtual effect; and
determining, when no obstacle exists between the first body part of the plurality of body parts and the virtual effect, that the first body part is affected by the virtual effect.

7. The method according to claim 1, wherein the determining the change to the attribute value comprises:
determining the change to the attribute value of the virtual object based on (i) the sub-attribute change value of each of the plurality of body parts of the virtual object that is affected by the virtual effect and (ii) at least one of a distance factor, an armor factor, a projection relationship factor, a posture factor of the virtual object, a resistance factor, or a duration factor.

8. The method according to claim 1, further comprising:
determining connecting lines respectively corresponding to the plurality of body parts to the virtual effect;
determining when the connecting line of a respective body part of the plurality of body parts to the virtual effect is blocked, that an obstacle exists between the respective body part and the virtual effect; and
determining, when the connecting line of the respective body part connects to the virtual effect, that no obstacle exists between the respective body part and the virtual effect.

9. The method according to claim 1, wherein the determining the sub-attribute change value for each of the plurality of body parts comprises:
obtaining a reference attribute value corresponding to one of the plurality of body parts; and
determining the sub-attribute change value for the one of the plurality of body parts based on the reference attribute value and an adjustment coefficient associated with the one of the plurality of body parts.

10. The method according to claim 6, further comprising:
determining whether the obstacle exists based on a characteristic of an object in the virtual scene that is between the first body part and the virtual effect.

11. The method according to claim 6, wherein the obstacle includes a virtual wall between the virtual effect and the first body part.

12. The method according to claim 1, wherein
the virtual effect decreases the attribute value of the virtual object when the virtual effect is of a first type; and
the virtual effect increases the attribute value of the virtual object when the virtual effect is of a second type of action.

13. The method according to claim 1, further comprising:
displaying the change to the attribute value of the virtual object.

14. An apparatus, comprising:
processing circuitry configured to:
generate a virtual effect in a virtual scene, the virtual effect being configured to change an attribute value of a virtual object that is located within a functional range of the virtual effect;
determine, based on positional relationships between a plurality of body parts of the virtual object and the virtual effect in the virtual scene, a sub-attribute change value for each of the plurality of body parts of the virtual object that is affected by the virtual effect; and
determine a change to the attribute value of the virtual object based on the sub-attribute change value of each of the plurality of body parts of the virtual object that is affected by the virtual effect.

15. The apparatus according to claim 14, wherein the sub-attribute change value of a first body part of the plurality of body parts that is affected by the virtual effect is different from the sub-attribute change value of a second body part of the plurality of body parts that is affected by the virtual effect.

16. The apparatus according to claim 14, wherein the plurality of body parts includes at least one appendage of the virtual object.

17. The apparatus according to claim 14, wherein the virtual effect includes an explosion that is generated by a virtual prop thrown by another virtual object in the virtual scene.

18. The apparatus according to claim 14, wherein the processing circuitry is configured to:
determine the change to the attribute value based on a weighted sum of the sub-attribute value change of each of the plurality of body parts of the virtual object that is affected by the virtual effect.

19. The apparatus according to claim 14, wherein the processing circuitry is configured to:
determine, when an obstacle exists between a first body part of the plurality of body parts and the virtual effect, that the first body part is not affected by the virtual effect; and
determine, when no object exists between the first body part of the plurality of body parts and the virtual effect, that the first body part is affected by the virtual effect.

20. A non-transitory computer-readable storage medium, storing instructions which when executed by a processor cause the processor to perform:
generating a virtual effect in a virtual scene, the virtual effect being configured to change an attribute value of a virtual object that is located within a functional range of the virtual effect;
determining, based on positional relationships between a plurality of body parts of the virtual object and the virtual effect in the virtual scene, a sub-attribute change value for each of the plurality of body parts of the virtual object that is affected by the virtual effect; and
determining a change to the attribute value of the virtual object based on the sub-attribute change value of each of the plurality of body parts of the virtual object that is affected by the virtual effect.
